(19) United States
(12) Patent Application Publication
(10) Pub. No.: US 2026/0220998 A1
(43) Pub. Date: Jul. 30, 2026

(54) GAMING MACHINE, METHOD FOR PROVIDING GAME, AND STORAGE MEDIUM

(71) Applicant: Konami Gaming, Inc., Las Vegas, NV (US)

(72) Inventor: Soichiro KANAE, Kanagawa (JP)

(21) Appl. No.: 19/629,140

(22) Filed: Mar. 26, 2026

Related U.S. Application Data
(63) Continuation-in-part of application No. 19/343,880, filed on Sep. 29, 2025.

(30) Foreign Application Priority Data
Sep. 30, 2024 (JP) 2024-170104

(51) Int. Cl. G07F 17/32

(52) U.S. Cl. CPC G07F 17/3213; G07F 17/3216; G07F 17/3244; G07F 17/3267

(57) ABSTRACT

A gaming machine for displaying a computer-animated reel game is described herein. The gaming machine includes one or more processors programmed to execute an algorithm to display an animated sequence of computer-generated images of the computer-animated reel game on a display device GUI including the steps of initiating a prize upgrade animation sequence by randomly selecting a number of cells displaying prize symbols based on the number of collected prize upgrade symbols included in a prize upgrade symbol meter, determining a type of prize symbol being displayed in each selected cell, accessing a prize upgrade data lookup table to determine an upgrade prize symbol associated with each type of prize symbol being displayed in each selected cell, and sequentially animating each associated upgrade prize symbol to replace a corresponding prize symbol displayed in each selected cell.

### CROSS-REFERENCE TO RELATED APPLICATIONS

This application is a continuation-in-part of U.S. Patent Application Serial No. 19/343,880, filed September 29, 2025, which claims the benefit of priority from Japanese Patent Application No. 2024-170104, filed on September 30, 2024, the entire contents of which are incorporated herein by reference.

### TECHNICAL FIELD

The present disclosure relates to a gaming machine, a method for providing a game, and a storage medium.

### BACKGROUND

US Patent Application Publication No. 2024/0249596 discloses a gaming machine that provides a slot game. This gaming machine accumulates gameplay enhancers in response to the appearance of a first symbol during a base game. The gameplay enhancers are specific symbols or functions used during a bonus game to enhance gameplay. This gaming machine applies the gameplay enhancers accumulated in the base game during the bonus game.

### SUMMARY OF THE INVENTION

In the gaming machine described in US Patent Application Publication No. 2024/0249596, the bonus game is triggered not only from the base game but also from special games such as free games. However, there is no difference in the benefits obtained from the triggered bonus game, regardless of whether triggered from the base game or the free game. Therefore, with respect to the triggered bonus game, the special game doesn’t have an advantage over the base game. In view of such related art, an object of the present disclosure is to provide a gaming machine, a method for providing a game, or a system or a storage medium for storing a program that implements a game mechanics where a special game triggers more advantageous bonus game than a normal game does. Note that "gameplay" as used in this specification is a general term for rules for game progression, a mechanism for generating a win, a system for determining an award amount, and the like. Furthermore, the term “game mechanics” as used in this specification refers to the rules, mechanisms, algorithms, systems, etc. that provide the gameplay to players.

A gaming machine according to one aspect of the present disclosure includes: a display unit; and a control unit connected to the display unit and configured to provide a normal game and a special game, which are slot games, wherein the control unit is configured to: add the number of times a special symbol has appeared in a result of the normal game to an initial value to set a feature count; in response to a feature event occurring in the result of the normal game, provide game features for the number of times equal to the feature count; when an event that triggers the special game occurs in the normal game, provide the special game for a predetermined number of times; further add the number of times the special symbol has appeared in a result of the special game to the feature count; and in response to the feature event occurring in the result of the special game, provide the game features for the number of times obtained by adding a predetermined number of times to the feature count.

In this gaming machine, the feature count is accumulated when a special symbol is included in the game result in the normal game. Then, in response to a feature event occurring in the result of the normal game, game features for the number of times equal to the accumulated feature count are provided. When an event that triggers the special game occurs in the normal game, the special game is provided for a predetermined number of times, the number of times the special symbol has appeared in the result of the special game is further added to the feature count, and in response to a feature event occurring in the result of the special game, game features for the number of times obtained by adding a predetermined number of times to the accumulated feature count are provided. In this way, the number of times the game features are provided is greater when a feature event occurs in the special game than when a feature event occurs in the normal game. Therefore, it is possible to increase the player's anticipation for the special game. Thus, this gaming machine implements a game mechanics that can provide a more advantageous special game than the normal game.

In one embodiment, the control unit may provide a bonus game in response to a bonus event occurring in a result of the normal game or the special game, and provide the game features in the bonus game. Such a gaming machine can make the number of game features provided in a bonus game transitioned from the special game greater than the number of game features provided in a bonus game transitioned from the normal game. In this way, even in a game where the game features are not provided in the normal game or the special game but are provided in the bonus game, it is possible to provide a special game that is more advantageous than the normal game.

In one embodiment, the special symbol includes a first special symbol corresponding to a first game feature and a second special symbol corresponding to a second game feature, and the control unit is configured to: add the number of times the first special symbol and the second special symbol have appeared in the result of the normal game to initial values to set a first feature count and a second feature count, respectively; in response to a first feature event occurring in the result of the normal game, provide first game features for the number of times equal to the first feature count; in response to a second feature event occurring in the result of the normal game, provide second game features for the number of times equal to the second feature count; when an event that triggers the special game occurs in the normal game, provide the special game for a predetermined number of times; further add the number of times the first special symbol and the second special symbol have appeared in a result of the special game to the first feature count and the second feature count, respectively; in response to the first feature event occurring in the result of the special game, provide the first game features for the number of times obtained by adding a predetermined number of times to the first feature count; and in response to the second feature event occurring in the result of the special game, provide the second game features for the number of times obtained by adding a predetermined number of times to the second feature count. Such a gaming machine can accumulate the number of times the first and second game features are provided, and provide the first and second game features for the accumulated number of times. Then, the number of times the first and second game features are provided is greater when a feature event occurs in the special game than when a feature event occurs in the normal game. Thus, it is possible to provide a special game that is more advantageous than the normal game.

In one embodiment, the control unit may provide a bonus game in response to a bonus event occurring in the result of the normal game or the special game, and provide the first game feature and the second game feature in the bonus game. Such a gaming machine can set the number of the first and second game features provided in a bonus game transitioned from the special game greater than the number of the first and second game features provided in a bonus game transitioned from the normal game. In this way, even in a game where the first and second game features are not provided in the normal game or the special game but are provided in the bonus game, it is possible to provide a special game that is more advantageous than the normal game.

In one embodiment, the bonus game may be a game that provides a final result via an intermediate result, the first game feature may be one that ranks up the intermediate result to increase the final result, and the second game feature may be one that generates an additional award from the intermediate result. Such a gaming machine can provide various game features that are advantageous to the player.

A method for providing a game according to another aspect of the present disclosure is a method for providing a game executed by a gaming machine comprising a display unit and a control unit connected to the display unit and configured to provide a normal game and a special game, which are slot games, the method comprising the steps of: adding the number of times a special symbol has appeared in a result of the normal game to an initial value to set a feature count; in response to a feature event occurring in the result of the normal game, providing game features for the number of times equal to the feature count; when an event that triggers the special game occurs in the normal game, providing the special game for a predetermined number of times; further adding the number of times the special symbol has appeared in a result of the special game to the feature count; and in response to the feature event occurring in the result of the special game, providing the game features for the number of times obtained by adding a predetermined number of times to the feature count. This method for providing a game achieves the same effects as the gaming machine described above.

A storage medium according to another aspect of the present disclosure is a non-transitory computer-readable storage medium storing a program executed by a control unit in a gaming machine including a display unit and a control unit connected to the display unit and configured to provide a normal game and a special game, which are slot games, the program causing the control unit to: add the number of times a special symbol has appeared in a result of the normal game to an initial value to set a feature count; in response to a feature event occurring in the result of the normal game, provide game features for the number of times equal to the feature count; when an event that triggers the special game occurs in the normal game, provide the special game for a predetermined number of times; further add the number of times the special symbol has appeared in a result of the special game to the feature count; and in response to the feature event occurring in the result of the special game, provide the game features for the number of times obtained by adding a predetermined number of times to the feature count. This storage medium achieves the same effects as the gaming machine described above.

According to the present disclosure, a gaming machine, a method for providing a game, and a storage medium for storing a program implementing a game mechanics that can provide a higher advantageous special game over a normal game are provided. Note that the present disclosure is directed to a technical improvement for computer-implemented gaming machines. Specifically, it addresses the technical problem of how to present complex game state transitions and outcomes to a player in a clear and intuitive manner on a graphical user interface (GUI). The disclosed solution, involving a specific, ordered combination of steps performed by a processor, such as rendering, animating, and modifying graphical elements, improves the functioning of the computer itself by enhancing the human-machine interface and providing dynamic visual feedback that cannot be replicated by mental steps or with pen and paper.

In another aspect of the present invention, a gaming machine for displaying a computer-animated reel game is provided. The gaming machine includes a gaming cabinet, a display device mounted to the cabinet and including a graphical user interface (GUI) display screen displaying computer-generated images thereon, and a control unit operably coupled to the display device. The control unit includes a random number generator and one or more processors programmed to execute an algorithm to display an animated sequence of computer-generated images of the computer-animated reel game on the display device GUI including the steps of rendering a game screen on the display device GUI including a grid having a plurality of cells arranged in a three row by five column (3x5) matrix, a prize upgrade symbol meter displaying a number of collected prize upgrade symbols, and a prize reveal symbol meter displaying a number of collected prize reveal symbols, and rendering a plurality of individual reels within the grid displaying a plurality of game symbols. The plurality of individual reels includes a plurality of prize reels and a bonus feature reel with each prize reel displaying a plurality of prize symbols and a plurality of non-prize symbols and the bonus feature reel displaying a prize upgrade symbol, a prize reveal symbol, a wheel chance symbol, and a plurality of non-prize symbols. The one or more processors then initiate a spin of the reel game by animating the plurality of individual reels to spin and stop to display the game symbols within the grid including one or more prize symbols and the prize upgrade symbol. The one or more processors then initiate a prize upgrade animation sequence by randomly selecting a number of cells displaying prize symbols based on the number of collected prize upgrade symbols included in the prize upgrade symbol meter using the random number generator, determining a type of prize symbol being displayed in each selected cell, accessing a prize upgrade data lookup table to determine an upgrade prize symbol associated with each type of prize symbol being displayed in each selected cell, and sequentially animating each associated upgrade prize symbol to replace a corresponding prize symbol displayed in each selected cell.

In yet another aspect of the present invention, a method of operating a gaming machine is provided. The gaming machine includes a gaming cabinet, a display device mounted to the cabinet and including a graphical user interface (GUI) display screen displaying computer-generated images thereon, and a control unit including a random number generator and one or more processors coupled to the display device. The method includes the one or more processors performing an algorithm to display an animated sequence of computer-generated images of the computer-animated reel game on the display device GUI including the steps of rendering a game screen on the display device GUI including a grid having a plurality of cells arranged in a three row by five column (3x5) matrix, a prize upgrade symbol meter displaying a number of collected prize upgrade symbols, and a prize reveal symbol meter displaying a number of collected prize reveal symbols, and rendering a plurality of individual reels within the grid displaying a plurality of game symbols. The plurality of individual reels include a plurality of prize reels and a bonus feature reel, with each prize reel displaying a plurality of prize symbols and a plurality of non-prize symbols, and the bonus feature reel displaying a prize upgrade symbol, a prize reveal symbol, a wheel chance symbol, and a plurality of non-prize symbols. The one or more processors then initiate a spin of the reel game by animating the plurality of individual reels to spin and stop to display the game symbols within the grid including one or more prize symbols and the prize upgrade symbol. The one or more processors then initiate a prize upgrade animation sequence by randomly selecting a number of cells displaying prize symbols based on the number of collected prize upgrade symbols included in the prize upgrade symbol meter using the random number generator, determining a type of prize symbol being displayed in each selected cell, accessing a prize upgrade data lookup table to determine an upgrade prize symbol associated with each type of prize symbol being displayed in each selected cell, and sequentially animating each associated upgrade prize symbol to replace a corresponding prize symbol displayed in each selected cell.

In a further aspect of the present invention, a non-transitory computer-readable storage media having computer-executable instructions embodied thereon to operate a gaming machine for displaying a computer-animated reel game is provided. The gaming machine includes a gaming cabinet, a display device mounted to the cabinet and including a graphical user interface (GUI) display screen displaying computer-generated images thereon, and a control unit including a random number generator and one or more processors coupled to the display device. When executed by the one or more processors the computer-executable instructions cause the one or more processors to perform an algorithm to display an animated sequence of computer-generated images of the computer-animated reel game on the display device GUI including the steps of rendering a game screen on the display device GUI including a grid having a plurality of cells arranged in a three row by five column (3x5) matrix, a prize upgrade symbol meter displaying a number of collected prize upgrade symbols, and a prize reveal symbol meter displaying a number of collected prize reveal symbols, and rendering a plurality of individual reels within the grid displaying a plurality of game symbols. The plurality of individual reels include a plurality of prize reels and a bonus feature reel, with each prize reel displaying a plurality of prize symbols and a plurality of non-prize symbols, and the bonus feature reel displaying a prize upgrade symbol, a prize reveal symbol, a wheel chance symbol, and a plurality of non-prize symbols. The one or more processors then initiate a spin of the reel game by animating the plurality of individual reels to spin and stop to display the game symbols within the grid including one or more prize symbols and the prize upgrade symbol. The one or more processors then initiate a prize upgrade animation sequence by randomly selecting a number of cells displaying prize symbols based on the number of collected prize upgrade symbols included in the prize upgrade symbol meter using the random number generator, determining a type of prize symbol being displayed in each selected cell, accessing a prize upgrade data lookup table to determine an upgrade prize symbol associated with each type of prize symbol being displayed in each selected cell, and sequentially animating each associated upgrade prize symbol to replace a corresponding prize symbol displayed in each selected cell.

### BRIEF DESCRIPTION OF THE DRAWINGS

FIG. 1 is a perspective view illustrating an example of a gaming machine according to an embodiment.

FIG. 2 is a block diagram showing an example of the configuration of the gaming machine shown in FIG. 1.

FIG. 3 is a schematic diagram of a display area of the gaming machine of FIG. 1.

FIG. 4A is a diagram illustrating an example of a virtual reel strip used for cells other than a predetermined cell.

FIG. 4B is a diagram illustrating an example of a virtual reel strip used for the predetermined cell.

FIG. 5A is a diagram illustrating an example of symbols on a virtual reel strip used for cells other than a predetermined cell.

FIG. 5B is a diagram illustrating an example of symbols on a virtual reel strip used for the predetermined cell.

FIG. 6 is a diagram showing the relationship among a normal game, a special game, and a bonus game.

FIGS. 7A, 7B, 7C, and 7D are diagrams illustrating a state of a symbol arrangement in a normal game.

FIGS. 8A, 8B, 8C, and 8D are diagrams illustrating a state of a symbol arrangement in a bonus game.

FIGS. 9A, 9B, 9C, and 9D are diagrams illustrating a state of a symbol arrangement when a first feature is provided in a bonus game.

FIGS. 10A, 10B, 10C, and 10D are diagrams illustrating a state of a symbol arrangement when a second feature is provided in a bonus game.

FIGS. 11A, 11B, 11C, and 11D are diagrams illustrating a state of a symbol arrangement when a special game is triggered in a normal game.

FIG. 12 is a directory configuration diagram and a block diagram showing programs and data stored in the memory shown in FIG. 2.

FIG. 13 is a block diagram of a system for a gaming machine.

FIG. 14 is a block diagram of the game application program of FIG. 13.

FIG. 15 is a block diagram of the system application program shown in FIG. 13.

FIG. 16 is a flowchart for explaining the operation of the gaming machine.

FIG. 17 is a flowchart for explaining the operation of the gaming machine.

FIG. 18 is a flowchart for explaining the operation of the gaming machine.

FIG. 19 is a flowchart for explaining the operation of the gaming machine.

FIG. 20 is a flowchart for explaining the operation of the gaming machine.

FIG. 21 is a flowchart for explaining the operation of the gaming machine.

FIG. 22 is a diagram showing the relationship between a normal game and a special game.

FIGS. 23 and 24 are illustrations of exemplary data lookup tables that may be used when executing the algorithm shown in FIGS. 16-21.

FIGS. 25-32 are exemplary game screens of a computer-animated reel game illustrating a first game feature as an Explode Action prize upgrade animation sequence displayed when executing the algorithm shown in FIGS. 16-21.

FIGS. 33-37 are exemplary game screens of a computer-animated reel game illustrating a second game feature as a Bounty Action prize reveal animation sequence when executing the algorithm shown in FIGS. 16-21.

FIGS. 38-45 are exemplary game screens of a computer-animated reel game illustrating a wheel game as a Wheel Chance animation sequence displayed when executing the algorithm shown in FIGS. 16-21.

Corresponding reference characters indicate corresponding parts throughout the drawings.

### DETAILED DESCRIPTION

Hereinafter, a gaming machine according to an embodiment will be described with reference to the accompanying drawings. In the drawings, the same or corresponding parts are denoted by the same reference numerals, and redundant descriptions are omitted.

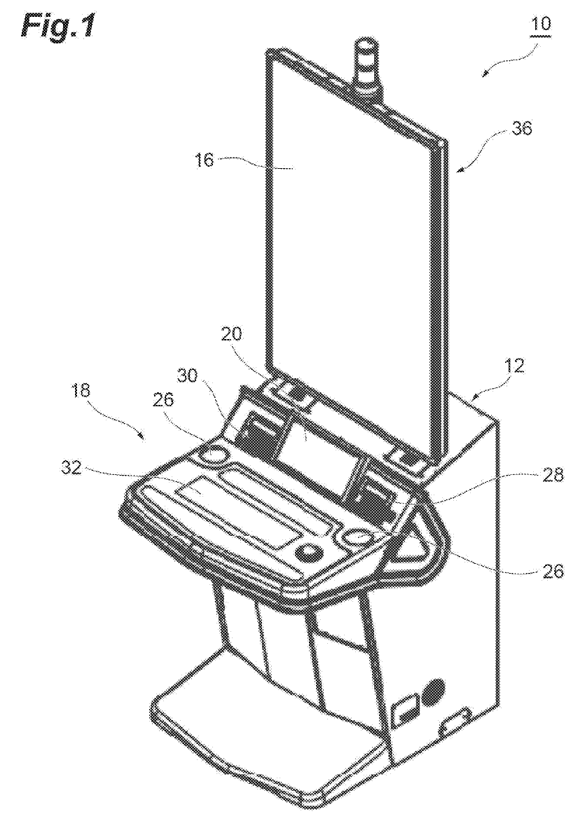

FIG. 1 is a perspective view illustrating an example of a gaming machine according to an embodiment. Here, a gaming machine is a device that accepts a wager such as cash, medals, or tokens from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. The gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a normal game, a free game, and a bonus game. The normal game, free game, and bonus game are provided when a predetermined condition is satisfied. In the normal game, free game, and bonus game, symbols displayed in the display region constitute a game result (such as a combination of symbols), and a winning is determined.

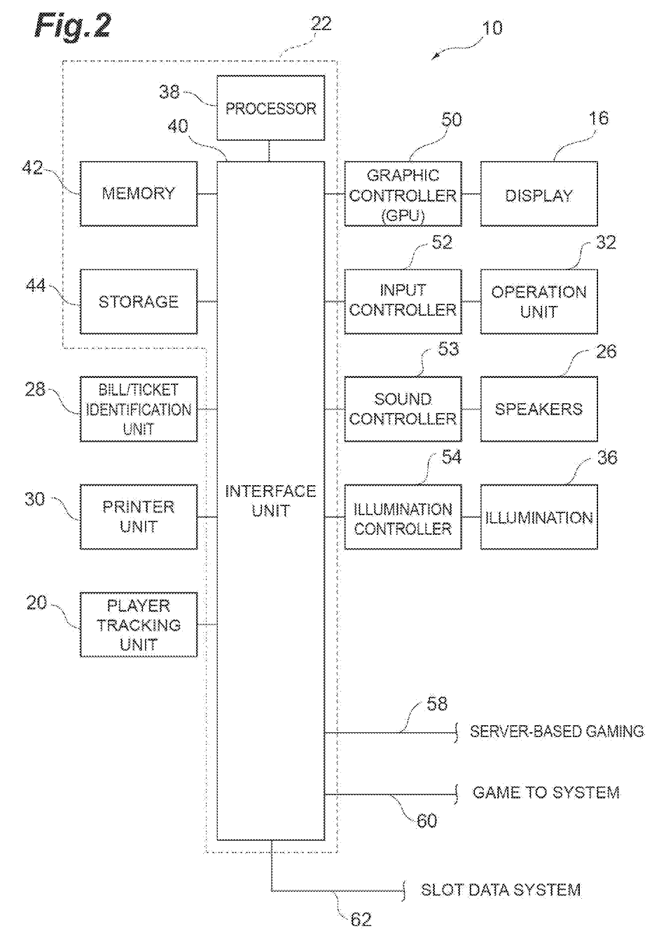

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device. The display 16 is controlled via the control unit 22 and includes a graphical user interface (GUI) display screen displaying computer-generated images thereon to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion opening. A bill/ticket storage part is provided on the output side of the identification part. The bill/ticket identification unit 28 accepts bill/tickets (including vouchers and coupons) that are gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchanged for cash at a kiosk terminal or a casino cage within the casino.

The operation unit 32 receives an operation of the player. The operation unit 32 includes a group of buttons for receiving various instructions from the player on the gaming machine 10. For example, the operation unit 32 may include a group of a spin button and setting buttons. The spin button receives an instruction to start an instance of a game (start rotation of reel). The group of setting buttons includes a group of bet buttons and the like, such as a cash-out button. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 that includes one or more processors constituting the control unit 22, an interface unit 40, a memory 42, a storage 44, and the like. The control unit 22 may be housed inside the cabinet 12 as a control board. The control unit 22 is configured to be able to communicate with each unit via the interface unit 40, and controls the operation of each unit by executing a program recorded in the memory 42 (an example of a storage unit) or the storage 44 (an example of a storage unit) of the CPU 38 to provide a game to the player.

The interface unit 40 includes a chipset that provides communication functions for the CPU 38, such as a memory bus connected to the CPU 38, various expansion buses, a serial interface, a universal serial bus (USB) interface, an Ethernet (registered trademark) interface, and the like.

The memory 42 may include a random-access memory (RAM) that is a volatile storage medium, a read-only memory (ROM) that is a non-volatile storage medium, and an electrically erasable programmable read-only memory (EEPROM) that is a rewritable non-volatile storage medium. The storage 44 provides the control unit 22 with a function as an external storage device, and can use a reader for a removable storage medium such as a memory card and a magneto-optical disk, and can also use a hard disk.

The bill/ticket identification unit 28, the printer unit 30, the player tracking unit 20, a graphics controller (GPU: Graphics Processing Unit) 50, an input controller 52, a sound controller 53, and an illumination controller 54 are connected to the interface unit 40. The graphics controller 50, the input controller 52, the sound controller 53, and the illumination controller 54 may be housed inside the cabinet 12 as control boards.

The control unit 22 is connected to the display 16 via the graphics controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the type of bills or payout processing of credit. The control unit 22 increases the credit amount usable in the game according to the notified contents. The printer unit 30 prints information corresponding to payout processing of credit from the gaming machine 10 on a ticket and outputs it under the control of the control unit 22 which receives the operation of a cash-out button included in the operation unit 32.

The player tracking unit 20 cooperates with the control unit 22 to transmit and receive player information and the like to and from a casino management system. The graphics controller 50 controls the display 16 under the control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the outside of the gaming machine 10. The interface unit 40 may communicate with external networks by Ethernet 58, 60 and a serial interface 62, as examples. FIG. 2 shows an example of communication with other gaming machines 10, a known server-side gaming network (Server-Based gaming), a G2S network (Game-to-System), and a slot information system (Slot Data System).

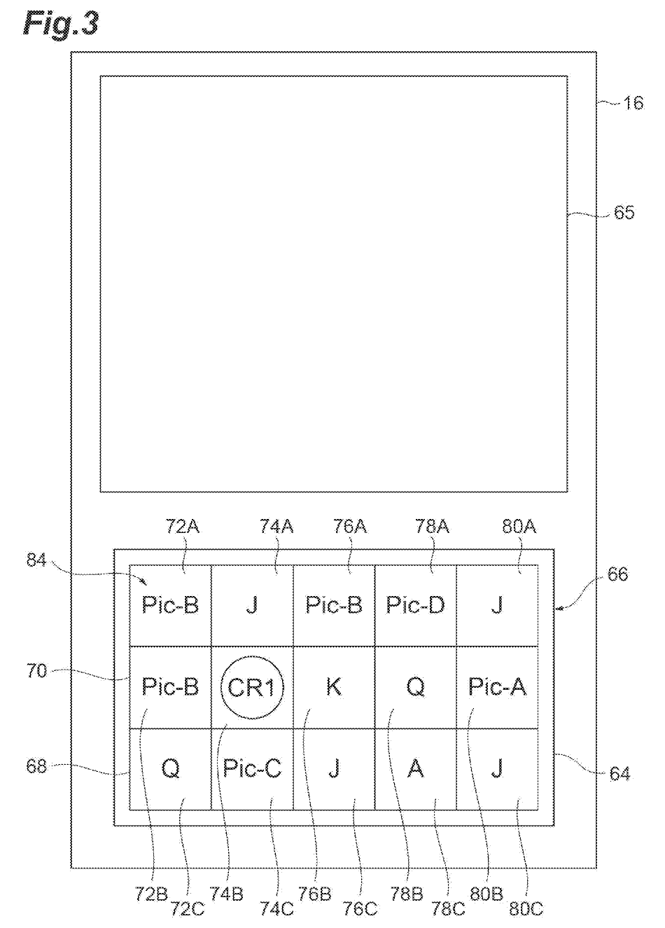

FIG. 3 is a schematic diagram of a display area of the gaming machine of FIG. 1. As shown in FIG. 3, a game screen is displayed in the display region of the display 16 by the control unit 22 executing a predetermined program. The game screen includes a symbol display region 64 for displaying a slot game. The symbol display region 64 is displayed in a lower region of the game screen as an example. Above the symbol display region 64, a region 65 is provided for displaying information related to the game and the like.

The symbol display region 64 includes a grid 68 capable of displaying symbols. By using such a display region, the gaming machine 10 operates as a slot machine that performs a winning determination according to a combination of symbols displayed on the grid 68 in the symbol display region 64 and provides a payout.

The display 16 displays a plurality of symbols in the grid 68. The grid 68 includes a plurality of rows and columns. The grid 68 is constituted by a plurality of cells 70 which are stop positions of symbols. FIG. 3 illustrates a game screen including a plurality of cells arranged in a 5×3 grid (matrix) pattern. The number of columns and the number of rows of the grid are not particularly limited, and may be another configuration such as 5×4, 3-4-4-4-3, 6×3, 6×4, or 3-3-3-5-5, or may be a configuration that increases or decreases according to the game progress and/or the bet amount. One symbol is stopped and displayed on each of the plurality of cells 70 in the symbol display region 64.

A symbol arranged in each of the plurality of cells 70 is determined by using a virtual reel strip for displaying a virtual reel 66. Hereinafter, the virtual reel 66 is also simply referred to as a reel. A virtual reel strip is provided for each cell. Such a reel is also referred to as an independent reel in contrast to a reel provided for each column of the grid.

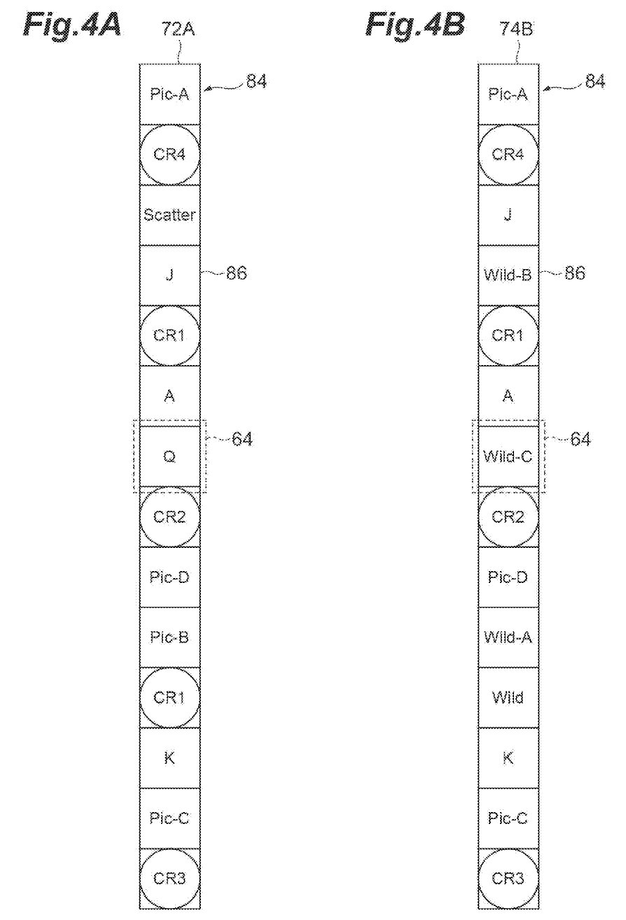

FIG. 4A is a diagram illustrating an example of a virtual reel strip used for cells other than a predetermined cell. FIG. 4B is a diagram illustrating an example of a virtual reel strip used for the predetermined cell. The predetermined cell can be, for example, the center cell in a 5×3 grid. The predetermined cell is not limited to the center cell and may be a cell at another position. Hereinafter, a case where only the center cell has a different virtual reel strip will be described as an example. Also, the virtual reel strip 72 will be described as a representative of the virtual reel strips except for the virtual reel strip 74B.

As shown in FIGS. 4A and 4B, the virtual reel strip includes a symbol arrangement indicating the order of symbols displayed in the symbol display region 64. On each cell 70 of the grid 68 shown in FIG. 3, symbols are displayed based on a symbol arrangement of the virtual reel 66 including virtual reel strips 72A, 72B, 72C, 74A, 74B, 74C, 76A, 76B, 76C, 78A, 78B, 78C, 80A, 80B, and 80C, which form a virtual reel set. That is, the virtual reel strips 72A to 80C are associated with each cell 70 of the grid 68, and the symbols arranged in predetermined parts of each virtual reel strip 72A to 80C are displayed. For example, the virtual reel strip 72A shown in FIG. 4A corresponds to the cell at the upper left end. The other virtual reel strips, except for the virtual reel strip 74B, are configured similarly to the virtual reel strip 72A and correspond to respective cells. The virtual reel strip 74B differs from the virtual reel strips of other cells in the types of symbols that can be displayed, and is otherwise the same. Furthermore, by moving (scrolling or spinning) each symbol by column based on the symbol arrangement of the virtual reel strips 72A to 80C, the symbols displayed in the cells 70 of the grid 68 change, and by stopping the movement (scrolling or spinning) by cell, the symbols are stopped. Here, the virtual reel strips 72A to 80C are data, and the control unit 22 uses a program included in the memory 42 or the storage 44, and data for displaying the symbol arrangement (i.e., the order of symbols on each reel strip) adjusted for each cell. The virtual reel set is a general term for such virtual reel strips 72A to 80C.

The virtual reel strips 72A and 74B shown in FIGS. 4A and 4B are composed of symbols 84 at each symbol position 86, and these symbols are arranged in an order defined for each reel. The number of symbols forming the virtual reel strip 72A is not limited to this and can be a desired number. The same applies to the other virtual reel strips. Also, in the virtual reel strips, the number of symbols may be the same or may be different from each other.

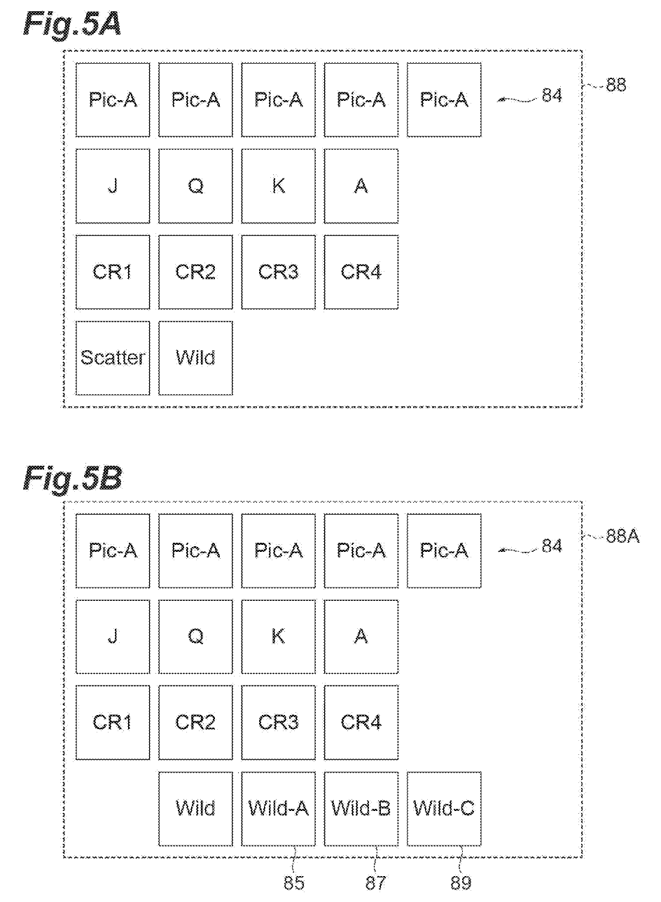

FIG. 5A is a detail of the symbol 84 shown in FIG. 4A. Each of the virtual reel strips 72A to 80C (excluding the virtual reel strip 74B) includes symbols selected from a symbol set 88 of various symbols 84 shown in FIG. 5A. The symbol set 88 includes, as standard symbols, card symbols ("J", "Q", "K", and "A") imitating playing cards, and picture symbols ("Pic-A", "Pic-B", "Pic-C", "Pic-D", and "Pic-E") indicating pictures of persons, animals, plants, articles, and the like.

The symbol set 88 includes prize symbols ("CR1", "CR2", "CR3", and "CR4"). A prize symbol is a symbol to which an award amount is assigned. As an example, a prize symbol is a picture symbol such as a treasure or wealth. The prize symbol has a rank corresponding to the award amount. For example, the prize symbol "CR1" is assigned a credit amount of "100", the prize symbol "CR2" is assigned a credit amount of "200", the prize symbol "CR3" is assigned a credit amount of "300", and the prize symbol "CR4" is assigned a credit amount of "400". That is, the prize symbol "CR1" is the lowest rank symbol, and the prize symbol "CR4" is the highest rank symbol. The prize symbol may be a credit symbol to which a predetermined credit amount is assigned as an award. The prize symbol may be a jackpot symbol to which a jackpot tier (rank) is assigned instead of a credit amount. The jackpot tier is a category corresponding to the size of the winning award, such as MINI, MAJOR, MAXI, MEGA, GRAND, and the like. For example, MINI is converted to a credit amount of "100", MAJOR to "500", MAXI to "1000", MEGA to "5000", and GRAND to "10000".

The symbol set 88 may include a wild symbol ("Wild") that is substituted for another symbol when determining a winning combination, and a scatter symbol ("Scatter") that triggers a special game in response to the appearance of a predetermined number of them when determining a winning combination.

FIG. 5B is a detail of the symbol 84 shown in FIG. 4B. The virtual reel strip 74B includes symbols selected from a symbol set 88A of various symbols 84 shown in FIG. 5B. The symbol set 88A, similar to the symbol set 88, includes card symbols, picture symbols, and prize symbols. The symbol set 88A may include a wild symbol.

The symbol set 88A includes special symbols related to the progress of the game. The special symbols include a first special symbol 85 ("Wild-A"), a second special symbol 87 ("Wild-B"), and a third special symbol 89 ("Wild-C"). In a predetermined game (e.g., a normal game and a special game), the first special symbol 85, the second special symbol 87, and the third special symbol 89, like a wild symbol, are substituted for other symbols when determining a winning combination. Then, the first special symbol 85 and the second special symbol 87 are collected when they appear in a game result and satisfy a predetermined condition. Collection means holding (accumulating) them so that they can be used in a later process. The accumulated number of the first special symbol 85 is used to calculate the number of times a first game feature described later is provided (first feature count). The accumulated number of the second special symbol 87 is used to calculate the number of times a second game feature described later is provided (second feature count). The third special symbol 89 triggers a wheel drawing game feature described later when it constitutes a game result.

In another predetermined game (e.g., a bonus game), the first special symbol 85, the second special symbol 87, and the third special symbol 89 serve as trigger symbols for game features. The first special symbol 85 is a trigger symbol for the first game feature, and the second special symbol 87 is a trigger symbol for the second game feature. In this way, the roles of the first special symbol 85 and the second special symbol 87 differ depending on the type of game. For example, depending on the type of game, the first special symbol 85 and the second special symbol 87 become either a symbol that increases the number of times a game feature is provided or a symbol that triggers a game feature.

A plurality of virtual reel sets may be prepared according to the game content. For example, the virtual reel set used in the normal game and the virtual reel set used in the special game may be the same or different. The virtual reel set in the special game may be configured to include more picture symbols, wild symbols, or special symbols than the virtual reel set in the normal game. By doing so, it is possible to increase the winning probability or expected value during the special game, and it is possible to provide the player with a valuable special game.

A payline is set in the symbol display region 64. The payline is set, for example, to span from a cell in the leftmost column to the rightmost column. As an example, a payline can be composed of any cell in the leftmost column, any cell in the second column from the left, any cell in the third column from the left, any cell in the fourth column from the left, and any cell in the fifth column from the left (the rightmost column). In a 5×3 matrix, 243 types (3 to the power of 5) of paylines can be set, but 40 or 50 types of these paylines may be set. In the so-called ALL-WAYS-WIN system, all 243 types of paylines are set as targets for win determination. Such a payline may be configured to be activated as a win line by being selected by the player. A win line is a payline that is a target for win determination. The number of win lines can be configured to be selectable by operating a group of line setting buttons included in the group of setting buttons of the operation unit 32 for the player. Also, it may be configured such that all set paylines are win lines, regardless of the player's selection.

The gaming machine 10 of the present embodiment provides three types of games: a normal game (also referred to as a main game or base game) provided when a predetermined condition is not satisfied, and a special game and a bonus game provided when a predetermined condition is satisfied. The normal game is a game provided as a compensation in response to the player consuming a game value. The special game is, for example, a free game provided without consuming a game value. In addition, the bonus game in the present embodiment is provided in association with the normal game or the special game, and is not provided independently of the normal game or the special game. The bonus game is, for example, a game that provides a final result via an intermediate result, and is, for example, a respin game described later.

In the above-described normal game, special game, and bonus game, a combination of symbols displayed in the symbol display region 64 among the symbol arrangement as a game result is a target for win determination. The control unit 22 starts the game and randomly determines the stopping position of each of the virtual reel strips 72A to 80C. The virtual reel strips 72A to 80C displayed on the display 16 move (scroll or spin) from the current position and stop at their respective stopping positions to represent the game result. Therefore, in the display 16 or the grid 68, the symbols included in the virtual reel strips 72A to 80C change in response to continuous movement (scrolling or spinning) in the vertical direction in the corresponding cell, and are displayed such that one symbol is stopped in one cell 70 according to the order of the symbols defined in the virtual reel strips 72A to 80C.

The control unit 22 may be configured to change a plurality of symbols displayed on the display 16 by the above-described method in accordance with the operation of the player received by the operation unit 32, stop the symbols in a predetermined order, and provide a payout in accordance with the combination of symbols stopped in the symbol display region 64.

The control unit 22 provides a predetermined number of special games when an event that triggers a special game occurs in the normal game. The event that triggers the special game and the predetermined number of times can be set arbitrarily. For example, it may be when a predetermined number of scatter symbols appear in the game result of the normal game. The special game may be provided based on another random number, regardless of the game result.

Furthermore, the control unit 22 provides a bonus game when a predetermined trigger condition is met in the normal game or the special game. Alternatively, the control unit 22 transitions the normal game or the special game to a bonus game when a predetermined trigger condition is met. In the bonus game, a reel that has once stopped is respun to provide a new combination of symbols. Such a bonus game is also called a respin game. The trigger condition can be set arbitrarily. The trigger condition is met, for example, when a bonus event occurs in the game result of the normal game or the special game. The bonus event may be, for example, that prize symbols form a series of adjacent symbols on a win line in the symbol combination as a game result of the normal game or the special game. In the case of the all-ways-win system, a series of adjacent symbols is formed, for example, when prize symbols are stopped in a region including at least three adjacent columns from the left end. The trigger condition may be met based on another random number, regardless of the game result.

When a bonus event occurs, the control unit 22 determines the reel to be respun. When a bonus event occurs in which prize symbols are stopped in a region including at least three adjacent columns from the left end, the control unit 22 determines the reels that have not stopped prize symbols as the reels to be respun.

The control unit 22 may determine the reel to be respun again if the intermediate result, that is, the new symbol combination formed after the respin, meets a predetermined condition. For example, if a new prize symbol connects to a series of adjacent symbols when the respun reel stops, that is, if a new prize symbol stops in a region including at least four adjacent columns from the left end, the control unit 22 determines the reel to be respun again. Connection means being adjacent in the arrangement of symbols on a win line. The control unit 22 determines the reels that have not stopped prize symbols as the reels to be respun.

If a predetermined trigger condition is not met after the respin, the control unit 22 ends the respin game. For example, if a new prize symbol does not connect to a series of adjacent symbols when the respun reel stops, the control unit 22 does not execute the next respin. If a series of adjacent symbols is formed by all reels, the control unit 22 ends the respin game because there is no reel to be respun.

The control unit 22 determines a win based on the final result, that is, the finally formed new combination of symbols. The control unit 22 may be configured to determine an award based on the symbols on the win line and provide the determined award to the player.

In the bonus game, the control unit 22 may apply a win determination method different from that of the normal game or the special game. For example, the control unit 22 provides the player with the award amount assigned to the prize symbols that formed a series of adjacent symbols on a win line. The control unit 22 may provide the player with the award amount assigned to the prize symbols that formed a series of adjacent symbols when a series of adjacent symbols consisting of a predetermined number or more of prize symbols is formed. Such a win determination method has a high affinity with a respin game, and can provide an opportunity to win or an opportunity to increase the award at the time of winning simply by selecting the reel to be respun.

When providing the player with the total award amount assigned to the prize symbols, the control unit 22 may display a frame in the symbol display region 64 to distinguish between prize symbols that are provided as an award at the time of winning and prize symbols that are not provided as an award at the time of winning. For example, when performing a respin, the control unit 22 displays an active area, which can form a series of adjacent symbols consisting of a predetermined number or more of prize symbols, enclosed by a frame. For example, if prize symbols have appeared in the first, second, and third columns from the left, the control unit 22 sets the area including the first to fourth columns as the active area and displays it enclosed by a frame. By paying attention to the frame, the player can understand at a glance that prize symbols stopped outside the frame do not contribute to the award.

If a new prize symbol stops in the fourth column, the control unit 22 expands the frame to include the fifth column as the active area. In this way, the frame is expanded each time the number of columns forming a series of adjacent symbols increases. The control unit 22 provides the player with the total award amount assigned to the prize symbols stopped within the area enclosed by the frame when the respin ends. By using the frame, the control unit 22 can allow the player to play the game without being conscious of the win lines.

Next, the game features of the normal game, special game, and bonus game will be described. In the gaming machine 10, a first game feature, a second game feature, and a third game feature are prepared. The number of game features can be set arbitrarily. For example, there may be one game feature, or four or more. Also, the game in which each game feature is provided can be set arbitrarily. For example, the first game feature and the second game feature may be provided only in the bonus game, or the first game feature, the second game feature, and the third game feature may be provided in all games. Hereinafter, an example will be described in which the first game feature and the second game feature are provided only in the bonus game, and the third game feature is provided in all games.

First, the first game feature will be described. The first game feature is one that, in a bonus game that provides a final result via an intermediate result, ranks up a symbol included in the intermediate result to increase the award obtained as the final result. For example, when the first game feature is applied, the prize symbol before the respin is ranked up. For example, the prize symbol "CR1" is ranked up to the prize symbol "CR2", the prize symbol "CR2" is ranked up to the prize symbol "CR3", and the prize symbol "CR3" is ranked up to the prize symbol "CR4". The rank-up is not limited to one level, but may be a two-level or three-level rank-up.

The first game feature may be configured to rank up one prize symbol each time it is provided once, or may be configured to rank up a plurality of prize symbols. The number of times the first game feature is provided (first feature count) is determined in the normal game or the special game.

First, a case will be described in which a bonus game is provided when a bonus event occurs in a normal game, and a first game feature is provided when a first feature event occurs in the bonus game. First, in the normal game, the number of times the first special symbol 85 has appeared in the game result is accumulated. Then, when a bonus event occurs in the normal game, the accumulated number of times is added to a predetermined initial value to set the first feature count. The initial value can be set arbitrarily. Note that the initial value may be displayed as the first feature count in advance, and the first feature count may be incremented each time the first special symbol 85 appears. The initial value may be a constant value or a value determined based on a random number. In the bonus game, when a first feature event occurs, the first game feature is provided for the number of times equal to the first feature count. For example, if the accumulated number of times is three and the initial value is one, the first game feature is provided four times when a first feature event occurs. As a result, for example, four prize symbols are ranked up.

Next, a case will be described in which a special game is provided when an event that triggers a special game occurs in a normal game, a bonus game is provided when a bonus event occurs in the special game, and a first game feature is provided when a first feature event occurs in the bonus game. First, in the normal game, the number of times the first special symbol 85 has appeared in the game result is accumulated. Then, when an event that triggers a special game occurs in the normal game, the accumulated number of times is added to a predetermined initial value to set the first feature count. Note that the initial value may be displayed as the first feature count in advance, and the first feature count may be incremented each time the first special symbol 85 appears. The initial value may be a constant value or a value determined based on a random number. Then, the first feature count in the normal game is carried over to the special game. At this time, a predetermined bonus count is awarded as a bonus for the special game. The bonus count can be set arbitrarily and may be a value determined based on a random number. The bonus count may be displayed in a manner that is distinguishable from the first feature count.

In the special game, similarly to the normal game, the number of times the first special symbol 85 has appeared in the game result is accumulated. Then, when a bonus event occurs in the special game, the number of times the first special symbol 85 has appeared is added to the first feature count. Note that the first feature count may be displayed in advance, and may be incremented each time the first special symbol 85 appears. In the bonus game, when a first feature event occurs, the first game feature is provided for the number of times obtained by adding the bonus count to the first feature count. For example, if the accumulated number of times is three, the initial value is one, and the bonus count is one, the first game feature is provided five times when a first feature event occurs. As a result, for example, five prize symbols are ranked up. In this way, triggering a bonus game in a special game results in a higher first feature count than triggering a bonus game in a normal game.

Next, the second game feature will be described. The second game feature is provided in response to the occurrence of a second feature event. The second feature event is, for example, that the game result of the bonus game includes the second special symbol 87 ("Wild-B"). The second game feature is one that, in a bonus game that provides a final result via an intermediate result, generates an additional award from the intermediate result. For example, when the second game feature is applied, the credit amount corresponding to the prize symbol before the respin can be acquired. For example, if the prize symbol is "CR1", the credit amount is "100"; if it is "CR2", the credit amount is "200"; if it is "CR3", the credit amount is "300"; and if it is "CR4", the credit amount is "400".

The second game feature may be configured to acquire the credit amount of one prize symbol each time it is provided once, or may be configured to acquire the credit amounts of a plurality of prize symbols. The number of times the second game feature is provided (second feature count) is determined in the normal game or the special game.

First, a case will be described in which a bonus game is provided when a bonus event occurs in a normal game, and a second game feature is provided when a second feature event occurs in the bonus game. First, in the normal game, the number of times the second special symbol 87 has appeared in the game result is accumulated. Then, when a bonus event occurs in the normal game, the accumulated number of times is added to a predetermined initial value to set the second feature count. The initial value can be set arbitrarily. Note that the initial value may be displayed as the second feature count in advance, and a value may be added to the second feature count each time the second special symbol 87 appears. The initial value may be a constant value or a value determined based on a random number. In the bonus game, when a second feature event occurs, the second game feature is provided for the number of times equal to the second feature count. For example, if the accumulated number of times is three and the initial value is one, the second game feature is provided four times when a second feature event occurs. As a result, for example, the total credit amount of four prize symbols is acquired.

Next, a case will be described in which a special game is provided when an event that triggers a special game occurs in a normal game, a bonus game is provided when a bonus event occurs in the special game, and a second game feature is provided when a second feature event occurs in the bonus game. First, in the normal game, the number of times the second special symbol 87 has appeared in the game result is accumulated. Then, when an event that triggers a special game occurs in the normal game, the accumulated number of times is added to a predetermined initial value to set the second feature count. Note that the initial value may be displayed as the second feature count in advance, and the second feature count may be incremented each time the second special symbol 87 appears. The initial value may be a constant value or a value determined based on a random number. Then, the second feature count in the normal game is carried over to the special game. At this time, a predetermined bonus count is awarded to the second feature count as a bonus for the special game. The bonus count can be set arbitrarily and may be a value determined based on a random number. The bonus count may be displayed in a manner that is distinguishable from the second feature count.

In the special game, similarly to the normal game, the number of times the second special symbol 87 has appeared in the game result is accumulated. Then, when a bonus event occurs in the special game, the number of times the second special symbol 87 has appeared is added to the second feature count. Note that the second feature count may be displayed in advance, and may be incremented each time the second special symbol 87 appears. In the bonus game, when a second feature event occurs, the second game feature is provided for the number of times obtained by adding the bonus count to the second feature count. For example, if the accumulated number of times is three, the initial value is one, and the bonus count is one, the second game feature is provided five times when a second feature event occurs. As a result, for example, the total credit amount of five prize symbols is acquired. In this way, triggering a bonus game in a special game results in a higher second feature count than triggering a bonus game in a normal game.

Finally, the third game feature will be described. In the normal game, special game, and bonus game, when the third special symbol 89 constitutes a game result, the control unit 22 provides a wheel drawing game and enhances the prize symbols. For example, the control unit 22 displays a wheel including "GRAND", "MAJOR", "10×", "5×", "3×", or "2×" in the region 65 above the symbol display region 64, and determines the award to be applied by drawing. The control unit 22 applies the determined award to the prize symbols displayed in the game result.

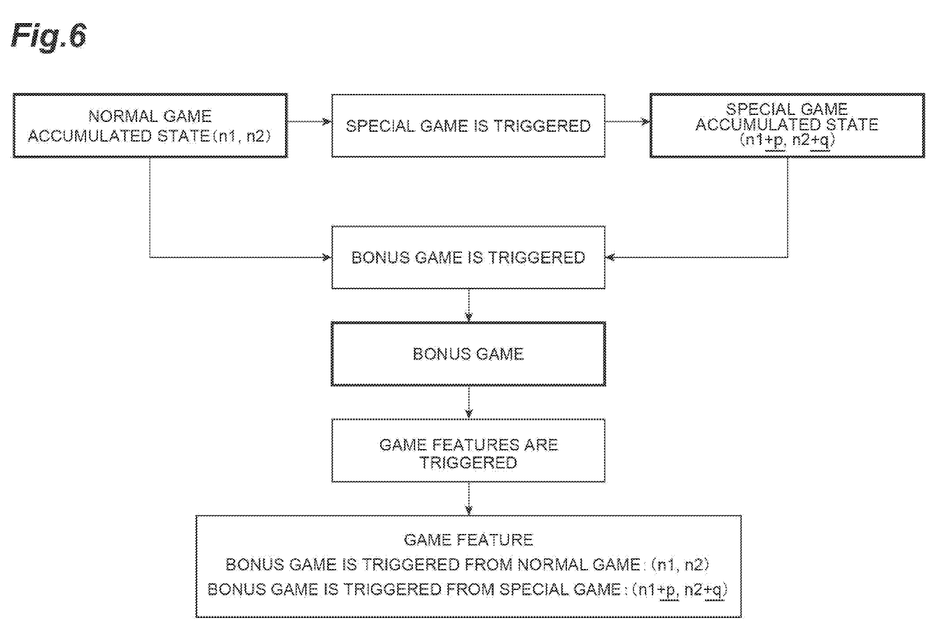

FIG. 6 is a diagram showing the relationship among a normal game, a special game, and a bonus game. As shown in FIG. 6, it is assumed that the first feature count n1 and the second feature count n2 described above have been accumulated in the normal game. When a special game is triggered in the normal game, a bonus count p is added to the first feature count n1, and a bonus count q is added to the second feature count n2. The first special symbol 85 and the second special symbol 87 are also accumulated in the special game, but this is omitted in FIG. 6.

When a bonus game is triggered from the normal game and provided, and the first game feature and the second game feature are triggered in the bonus game, the first game feature is provided for a number of times equal to the first feature count n1, and the second game feature is provided for a number of times equal to the second feature count n2. In contrast, when a bonus game is triggered from the special game and provided, and the first game feature and the second game feature are triggered in the bonus game, the first game feature is provided for a number of times obtained by adding the bonus count p to the first feature count n1, and the second game feature is provided for a number of times obtained by adding the bonus count q to the second feature count n2.

Hereinafter, the details of the normal game and the bonus game will be described using diagrams showing game screen transitions and symbol arrangements.

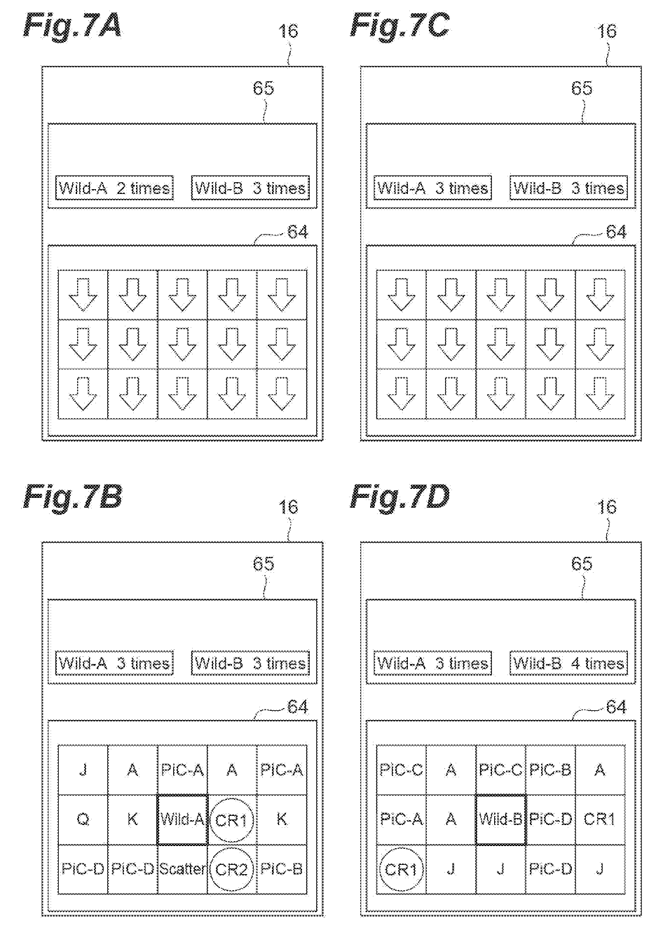

FIGS. 7A, 7B, 7C, and 7D are diagrams illustrating a game screen transition with a state of a symbol arrangement in a normal game. As shown in FIG. 7A, independent reels start spinning in the symbol display region 64. At this time, in the region 65 above the symbol display region 64, "Wild-A 2 times" is displayed as the first feature count, and "Wild-B 3 times" is displayed as the second feature count. It is assumed that these numbers already include the initial values.

Subsequently, as shown in FIG. 7B, each independent reel stops, and it is assumed that the first special symbol 85 ("Wild-A") is occurred in the center cell. In this case, one first special symbol 85 is collected. Then, the first feature count "Wild-A 2 times" is updated to the first feature count "Wild-A 3 times". Note that it may be determined whether to update with a certain probability after the first special symbol 85 is occurred.

Subsequently, as shown in FIG. 7C, a second normal game is executed, and independent reels start spinning in the symbol display region 64. At this time, in the region 65 above the symbol display region 64, "Wild-A 3 times" is displayed as the first feature count, and "Wild-B 3 times" is displayed as the second feature count.

Then, as shown in FIG. 7D, each independent reel stops, and it is assumed that the second special symbol 87 ("Wild-B") is occurred in the center cell. In this case, one second special symbol 87 is collected. Then, the second feature count is updated from "Wild-B 3 times" to "Wild-B 4 times". Note that it may be determined whether to update with a certain probability after the second special symbol 87 is occurred.

As shown in FIGS. 7A, 7B, 7C, and 7D, in the normal game, the first special symbol 85 and the second special symbol 87 are collected, and the first feature count and the second feature count are updated.

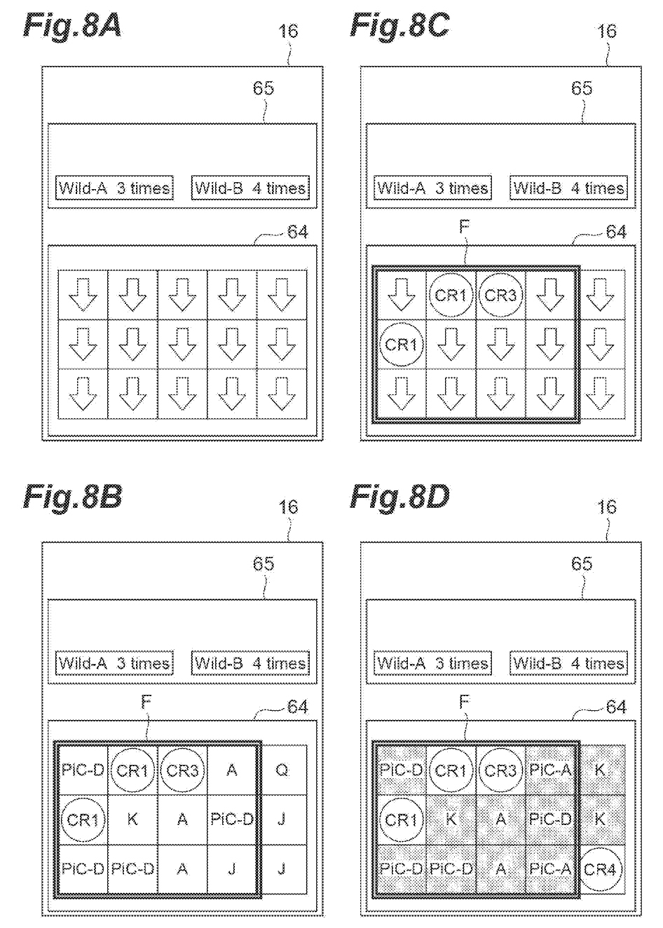

FIGS. 8A, 8B, 8C, and 8D, are diagrams illustrating a state of a symbol arrangement in a bonus game. FIG. 8A shows a normal game, and as shown in FIG. 8A, independent reels start spinning in the symbol display region 64. At this time, in the region 65 above the symbol display region 64, "Wild-A 3 times" is displayed as the first feature count, and "Wild-B 4 times" is displayed as the second feature count. It is assumed that these numbers already include the initial values.

Subsequently, as shown in FIG. 8B, each independent reel stops. At this time, it is assumed that the prize symbol "CR1" stops in the first column from the left, the prize symbol "CR1" stops in the second column, and further, the prize symbol "CR3" stops in the third column. In this case, it is determined that a bonus event has occurred, and a bonus game is provided. At this time, a frame F enclosing the first to fourth columns is displayed.

When the bonus game starts, as shown in FIG. 8C, the prize symbols are held, and the independent reels displaying symbols other than the prize symbols respin. Then, as shown in FIG. 8D, if no new prize symbol stops within the frame F, the bonus game ends. In this case, the total award amount assigned to the prize symbols existing within the frame F is awarded to the player. In the example shown in FIG. 8D, the total amount "500", which is the sum of the credit amount "100" corresponding to the prize symbol "CR1", the credit amount "100" corresponding to the prize symbol "CR1", and the credit amount "300" corresponding to the prize symbol "CR3", is awarded to the player.

If a new prize symbol stops within the frame F, the operation of holding the prize symbol and respinning the remaining independent reels is repeatedly executed. At this time, if a new prize symbol stops in the fourth column, the frame F is expanded to the fifth column.

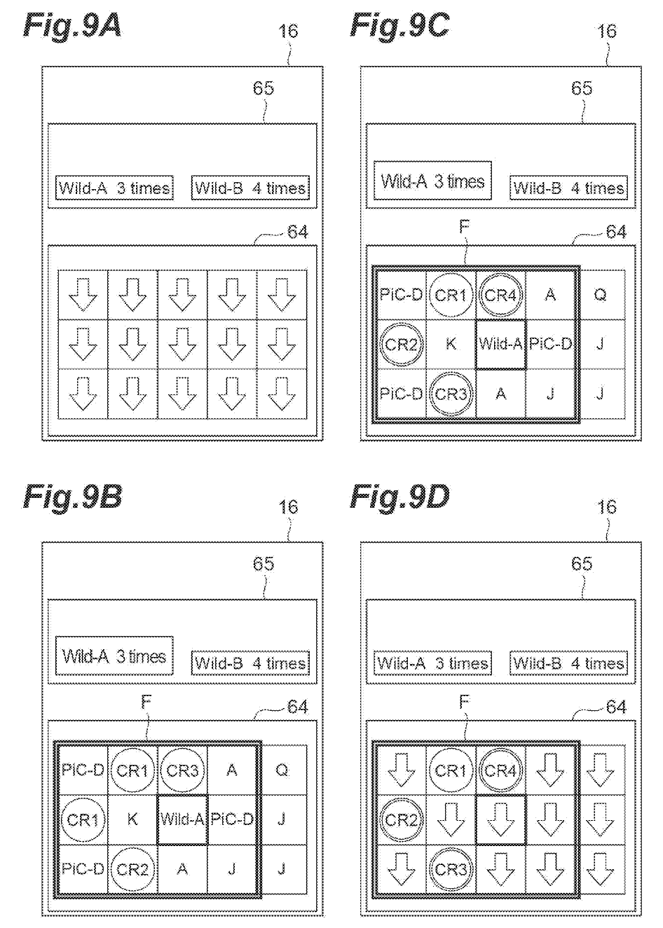

FIGS. 9A, 9B, 9C, and 9D, are diagrams illustrating a state of a symbol arrangement when a first feature is provided in a bonus game. FIG. 9A shows a normal game, and as shown in FIG. 9A, independent reels start spinning in the symbol display region 64. At this time, in the region 65 above the symbol display region 64, "Wild-A 3 times" is displayed as the first feature count, and "Wild-B 4 times" is displayed as the second feature count. It is assumed that these numbers already include the initial values.

Subsequently, as shown in FIG. 9B, each independent reel stops. At this time, it is assumed that the prize symbol "CR1" stops in the first column from the left, the prize symbols "CR1" and "CR2" stop in the second column, and further, the prize symbol "CR3" stops in the third column. In this case, it is determined that a bonus event has occurred, and a bonus game is provided. At this time, a frame F enclosing the first to fourth columns is displayed. Furthermore, the first special symbol 85 ("Wild-A") is stopped in the center cell. In this case, it is determined that a first feature event has occurred, and the first game feature is provided.

When the first game feature starts, as shown in FIG. 9C, since the first feature count is three, three of the four prize symbols displayed in the symbol display region 64 are selected and upgraded. For example, the prize symbol "CR1" in the first column is upgraded to "CR2". The prize symbol "CR2" in the second column is upgraded to "CR3". The prize symbol "CR3" in the third column is upgraded to "CR4". Thereafter, as shown in FIG. 9D, the prize symbols are held, and the independent reels displaying symbols other than the prize symbols respin. The subsequent content of the bonus game is the same as that described in FIGS. 8C and 8D.

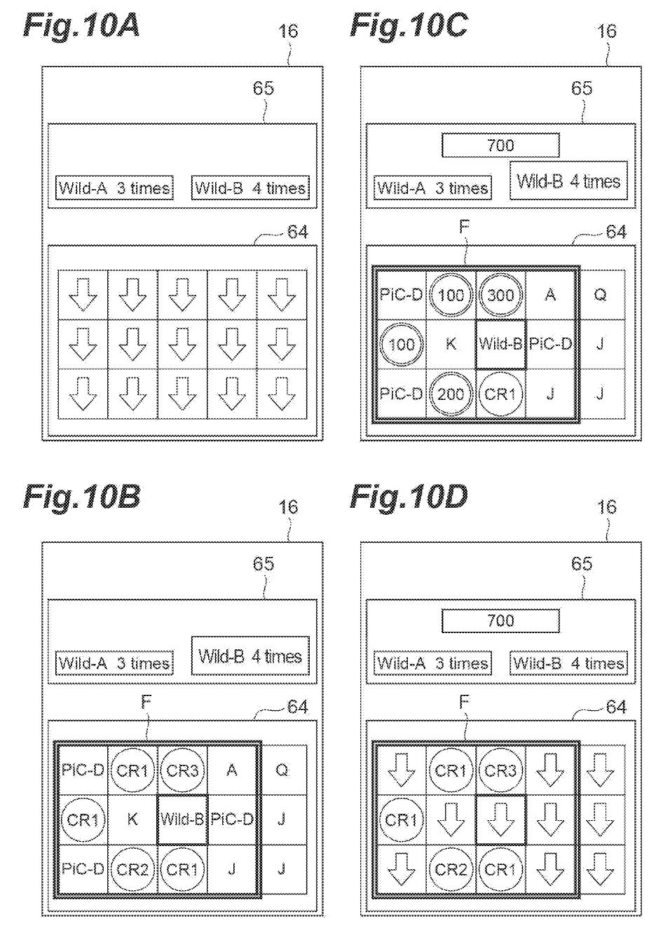

FIGS. 10A, 10B, 10C, and 10D, are diagrams illustrating a state of a symbol arrangement when a second feature is provided in a bonus game. FIG. 10A shows a normal game, and as shown in FIG. 10A, independent reels start spinning in the symbol display region 64. At this time, in the region 65 above the symbol display region 64, "Wild-A 3 times" is displayed as the first feature count, and "Wild-B 4 times" is displayed as the second feature count. It is assumed that these numbers already include the initial values.

Subsequently, as shown in FIG. 10B, each independent reel stops. At this time, it is assumed that the prize symbol "CR1" stops in the first column from the left, the prize symbols "CR1" and "CR2" stop in the second column, and further, the prize symbols "CR3" and "CR1" stop in the third column. In this case, it is determined that a bonus event has occurred, and a bonus game is provided. At this time, a frame F enclosing the first to fourth columns is displayed. Furthermore, the second special symbol 87 ("Wild-B") is stopped in the center cell. In this case, it is determined that a second feature event has occurred, and the second game feature is provided.

When the second game feature starts, as shown in FIG. 10C, since the second feature count is four, four of the five prize symbols displayed in the symbol display region 64 are selected and converted to the corresponding credit amounts. For example, the prize symbol "CR1" in the first column is converted to a credit amount of "100". The prize symbol "CR1" in the second column is converted to a credit amount of "100", and "CR2" is converted to a credit amount of "200". The prize symbol "CR3" in the third column is converted to a credit amount of "300". Then, the total amount "700" of these credit amounts is acquired and displayed in the region 65 above the symbol display region 64.

Thereafter, as shown in FIG. 10D, the prize symbols converted to credit amounts are returned to their original state. Then, the prize symbols are held, and the independent reels displaying symbols other than the prize symbols respin. The subsequent content of the bonus game is the same as that described in FIGS. 8C and 8D.

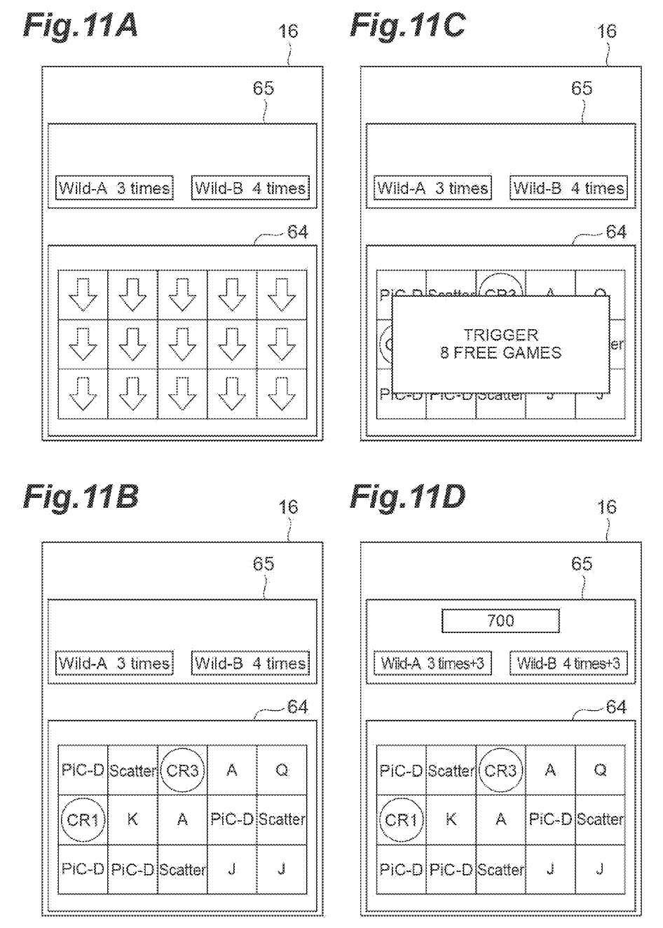

FIGS. 11A, 11B, 11C, and 11D, are diagrams illustrating a state of a symbol arrangement when a special game is triggered in a normal game. FIG. 11A shows a normal game, and as shown in FIG. 11A, independent reels start spinning in the symbol display region 64. At this time, in the region 65 above the symbol display region 64, "Wild-A 3 times" is displayed as the first feature count, and "Wild-B 4 times" is displayed as the second feature count. It is assumed that these numbers already include the initial values.

Subsequently, as shown in FIG. 11B, each independent reel stops. At this time, a predetermined number (here, three) or more of scatter symbols are displayed in the game result. In this case, it is determined that an event that triggers a special game has occurred, and a special game is provided. For example, as shown in FIG. 11C, a message "Trigger 8 Free Games" is displayed. Then, as shown in FIG. 11D, a bonus count is additionally displayed. In the region 65 above the symbol display region 64, "Wild-A 3 times + 3" is displayed as the first feature count, and "Wild-B 4 times + 3" is displayed as the second feature count. In this way, the bonus count is increased by three for each feature. Thereafter, a special game is provided. The special game differs from the normal game in the bonus count described above, and other game rules are basically the same.

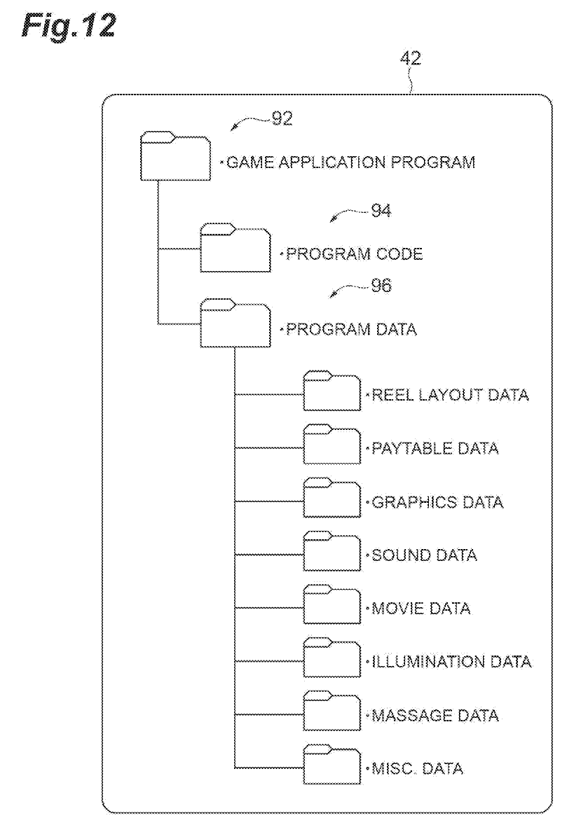

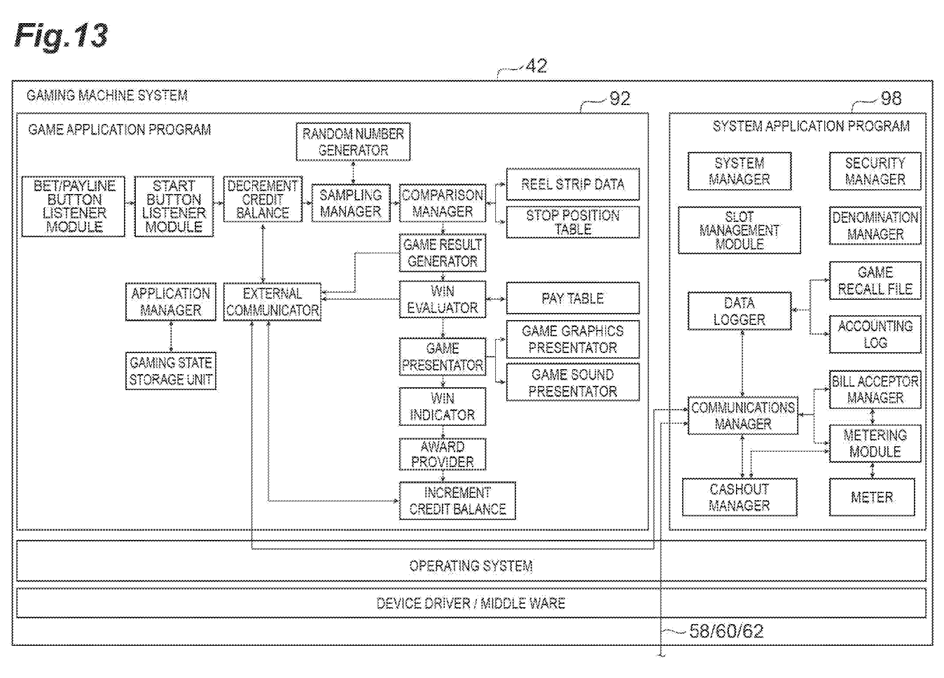

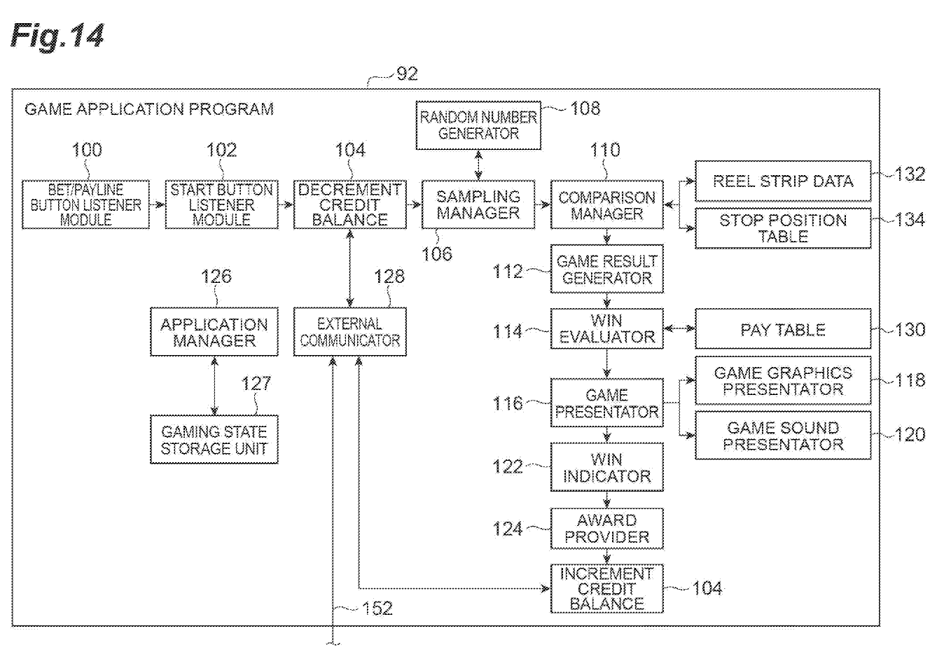

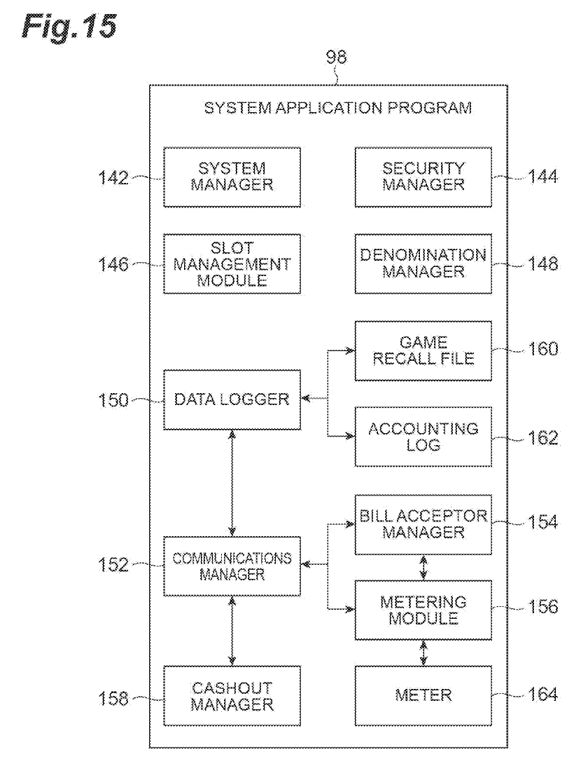

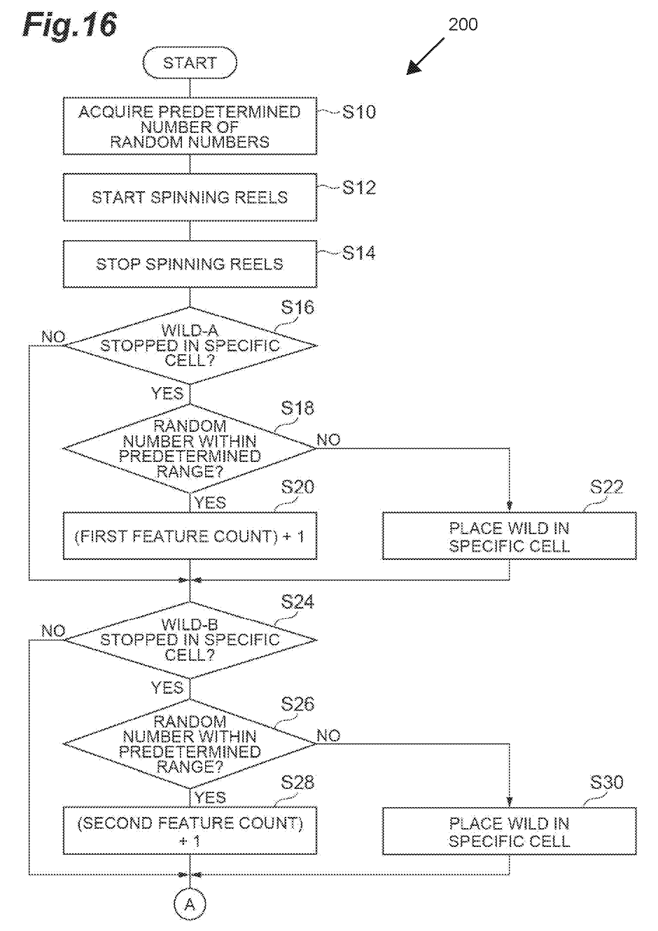

FIGS. 12 and 13 are a directory configuration diagram and a block diagram showing programs and data stored in the memory of FIG. 2. FIG. 14 is a block diagram of the game application program of FIG. 13. FIG. 15 is a block diagram of the system application program shown in FIG. 13. In the embodiments shown in FIGS. 12 to 15, the memory 42 stores a game application program 92 including computer-executable instructions, and processing of the game is performed by executing these computer-executable instructions in the CPU 38, and the game screen is displayed on the display 16 of the gaming machine 10. Also, in one embodiment, the game application program 92 includes program code 94 that includes computer-executable instructions for implementing a game using the algorithms shown in FIGS. 16 to 21, and program object data 96.

In an exemplary embodiment, the memory 42 stores the game application program 92 and a system application program 98 that include computer-executable instructions that are executed in the CPU 38 to process the game and display a game screen on the display 16 of the gaming machine 10. The game application program 92 provides a game-specific front-end function by being executed on the CPU, and the system application program 98 provides a generic back-end function. In the illustrated embodiment, the game application program 92 and the system application program 98 are implemented on the same operating system. However, these programs may be implemented on different operating systems or on different processors.

In one embodiment, the game application program 92 includes a plurality of software modules including a bet/payline button listener module 100, a start button listener module 102, a credit balance manager module 104, a sampling manager 106, random number generator (RNG) 108, a comparison manager 110, a game result generator 112, a win evaluator 114, a game presentator 116, a game graphics presentator 118, a game sound presentator 120, a win indicator 122, an award provider 124, an application manager 126, and an external communicator 128. The game application program 92 may also include a pay table 130, a reel strip data 132, and a stop position table 134.

The bet/payline button listener module 100 is a software module for receiving a signal from a bet button of the operation unit 32, and this signal is generated by the button when the player operates the button to select a bet amount. In response to receiving the signal, the bet/payline button listener module 100 communicates the occurrence of the signal to the application manager 126 to change the bet of the game.

The start button listener module 102 is a software module for receiving a signal from a start button, and this signal is generated when the player operates this button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on predetermined algorithm of computational random generation method. The random number generator 108 may be a pseudorandom generator. The random number generator 108 returns the random numbers in response to a request from the sampling manager 106. The random number generator 108 may be implemented in part or in whole as integrated circuits or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for a normal game, a free game, and a special game. The comparison manager 110 described above queries the application manager 126 to identify the current state of the game and selects a virtual reel strip.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of an inner symbol, and an attribute to be added. In one embodiment, the game result generator 112 may apply a change to the game result when a predetermined condition is met.

The win evaluator 114 evaluates the game result with reference to the pay table 130. To be specific, the winning evaluation is performed based on whether symbols defined as a winning combination in the pay table 130 stop.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbol formed in the game result. The award provider 124 provides award credit to the win meter based on the win evaluation.

The application manager 126 administrates the operation and state of each software module. In addition, the application manager 126 administrates the configuration, progress, and states of the game application program 92. The application manager 126 refers to a gaming state storage unit 127, determines the size of the symbol display region 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides background processing and functions other than game-specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the background processing and functions other than game-specific functions executed by the system application program 98.

The security manager 144 is a software module for administrating game verification, door security, and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars and the like. The data logger 150 is a software module for logging the results of each game in a game recall. In addition, the data logger 150 stores error events, bill logs, cashout logs, ticket logs, and the like in an accounting log.

The game recall file 160 is accumulated data including the results of each game. The game recall file 160 is stored in non-volatile memory. The accounting log 162 is accumulated data including error events, bill logs, cashout logs, ticket logs, and the like. The accounting log 162 is stored in non-volatile memory.

The communications manager 152 is a software module for administrating communication between the game application program 92 and the system application program 98. The communications manager 152 also administrates network communications between the system application program 98 and other gaming machines 10 and/or an external network (such as a slot management system network, a G2S network, a gaming server for a server-based gaming network, or a VLT system network).

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154 or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot and/or bill-in. These meters may be implemented as data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIGS. 16 to 21 are flowcharts illustrating an algorithm 200 executed by the CPU for operating the gaming machine to display an animated reel game 202. The algorithm 200 (gaming method) of the operation of the gaming machine is implemented in the game application program 92 and is embodied by the CPU 38 executing the game application program 92. The algorithm 200 for operation of the gaming machine includes a plurality of steps. Each step may be performed independently or may be performed in combination with other steps.

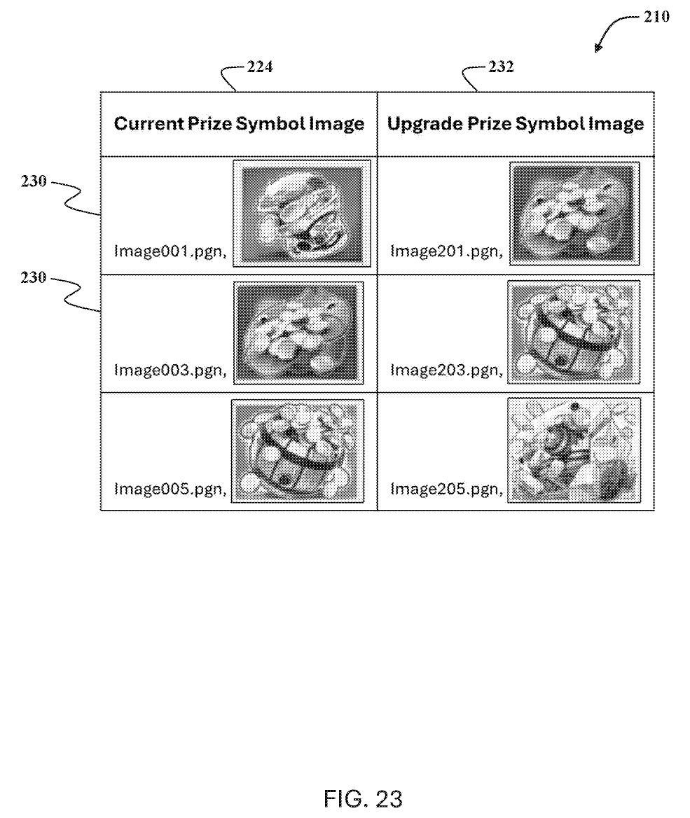

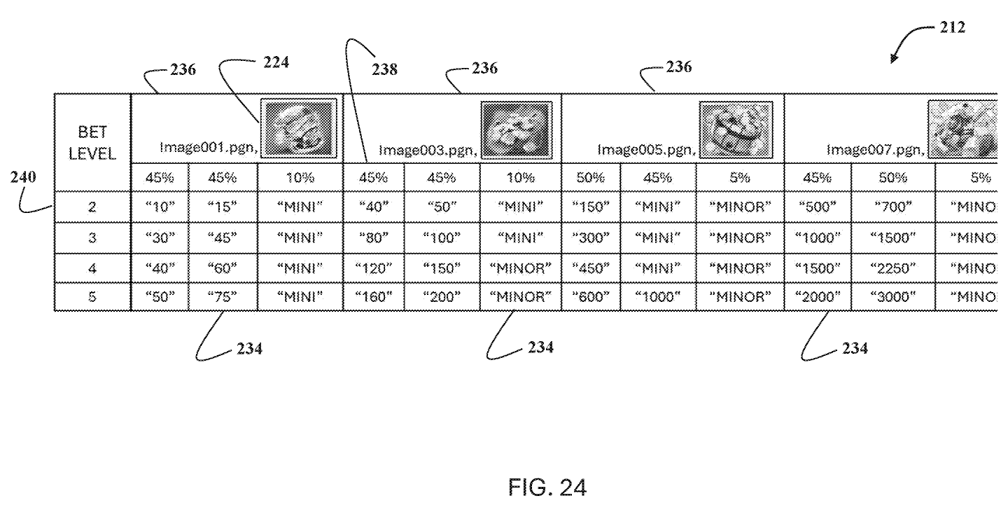

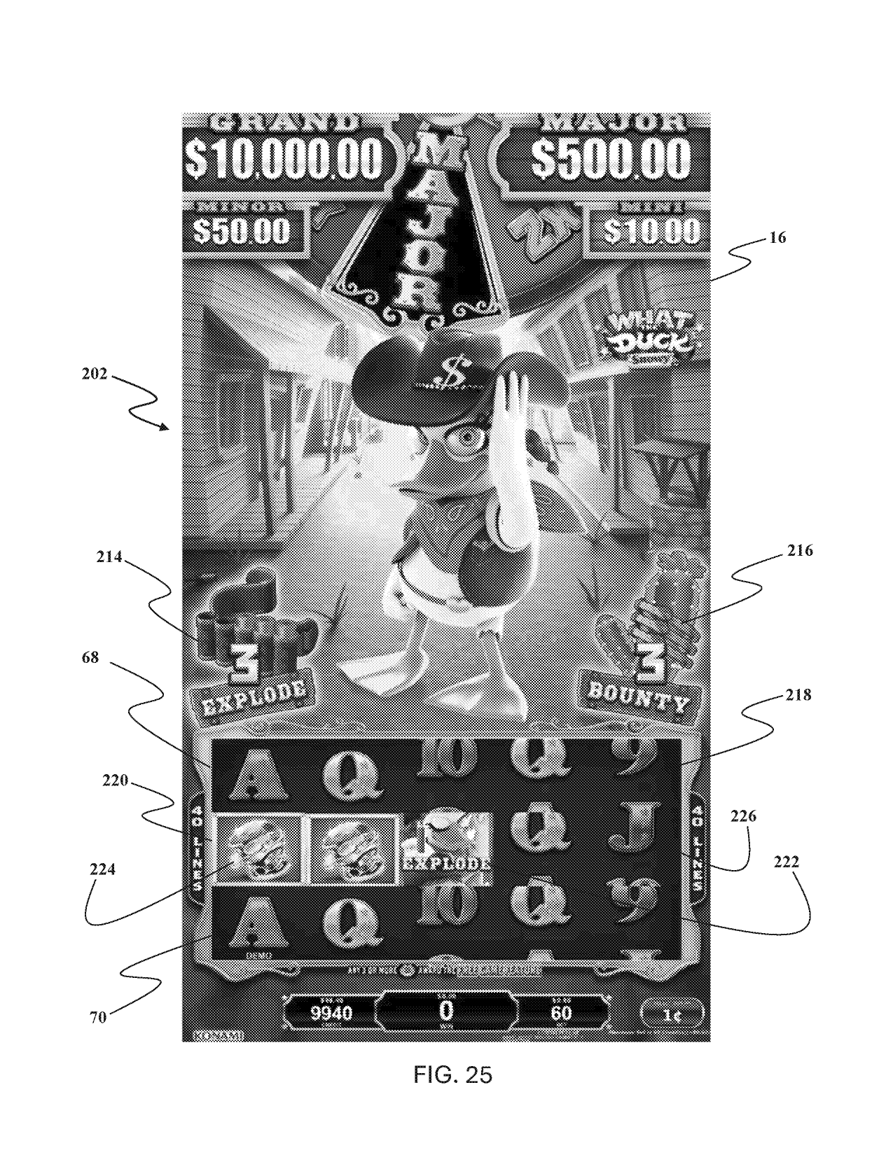

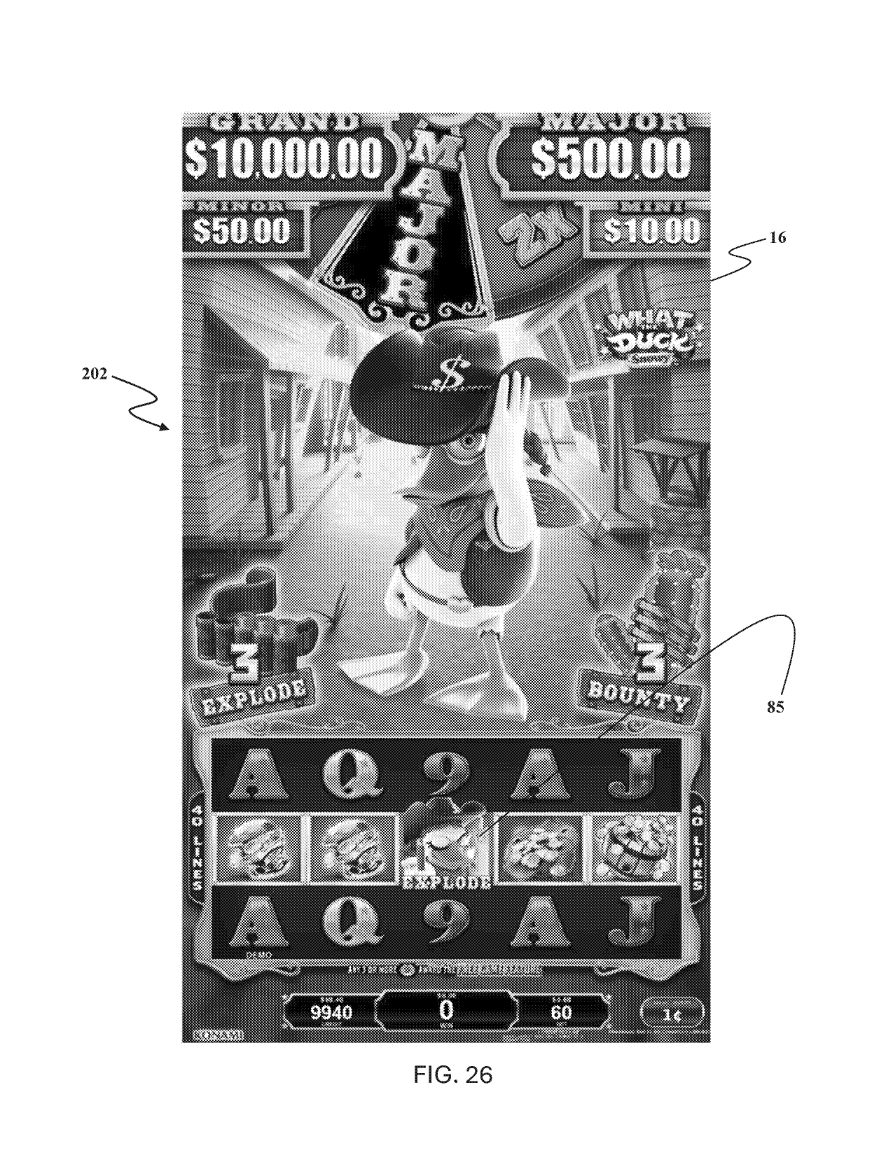

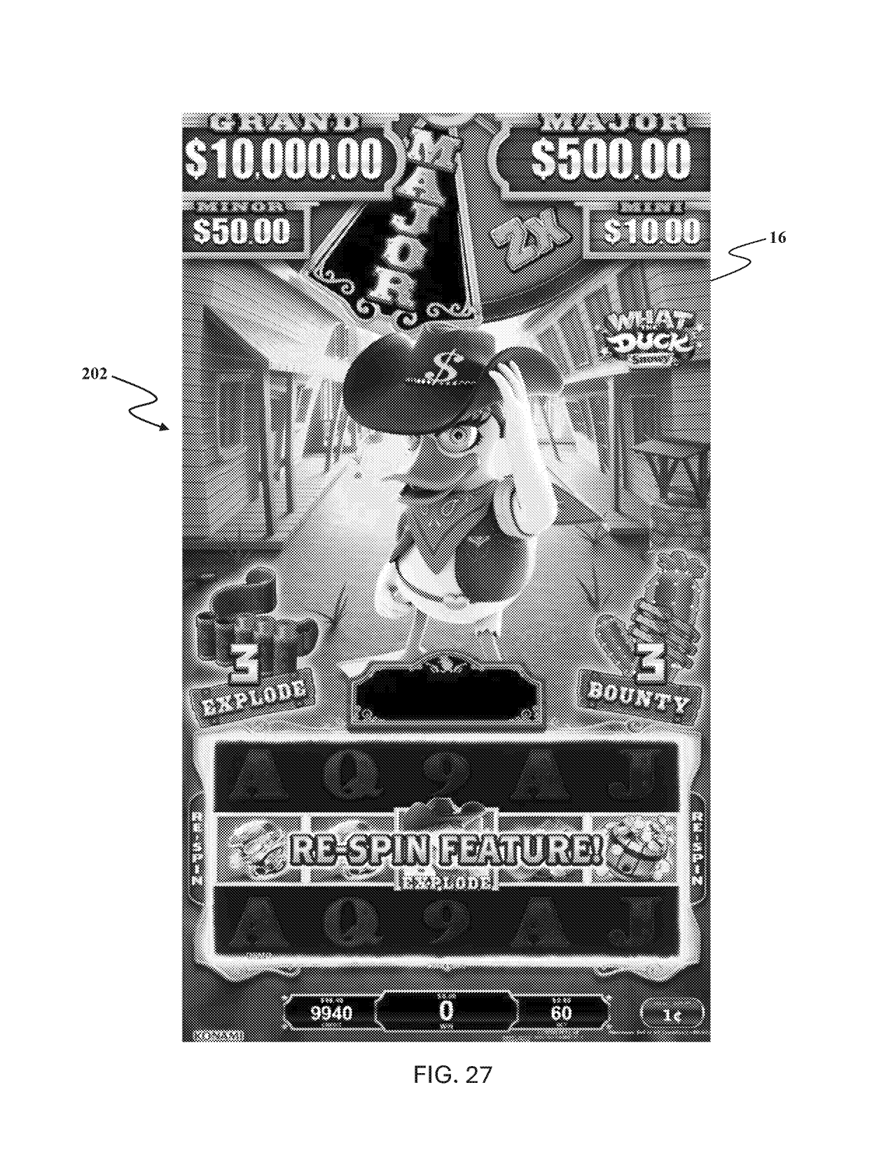

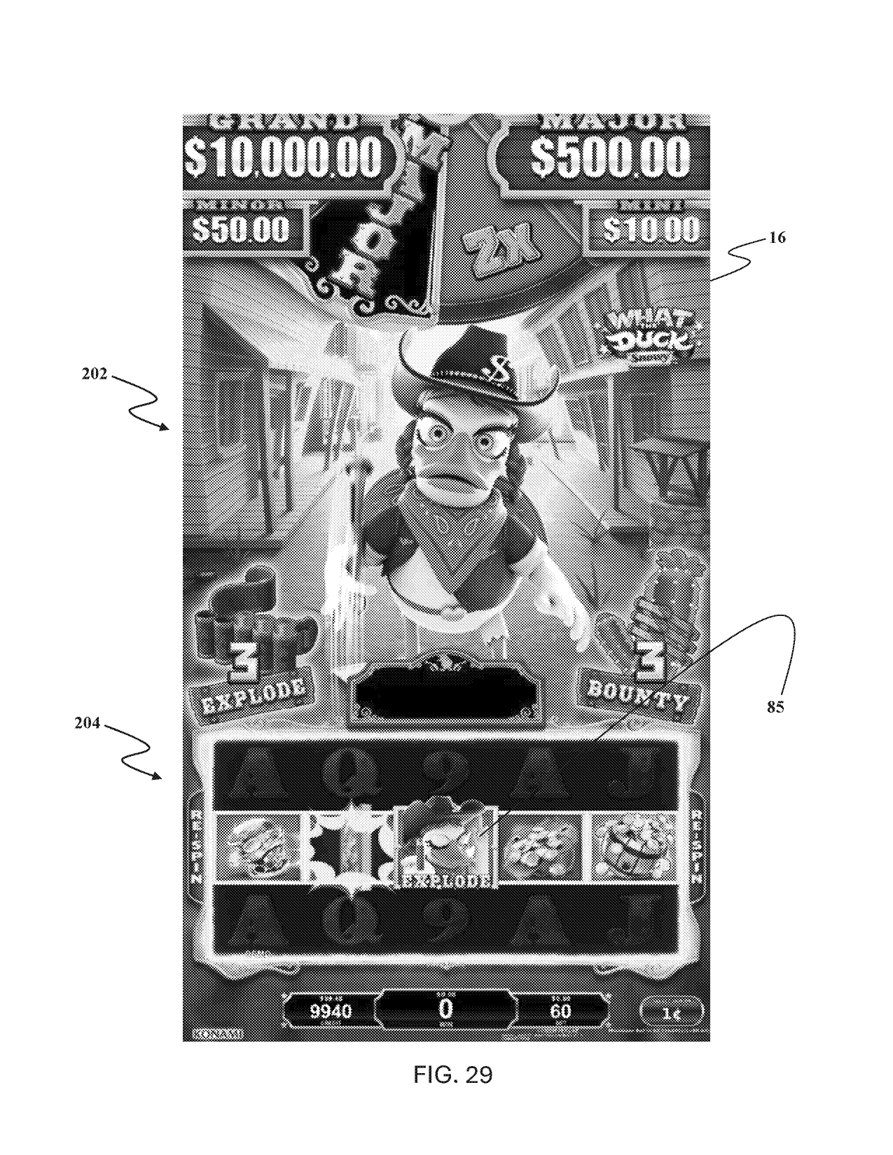

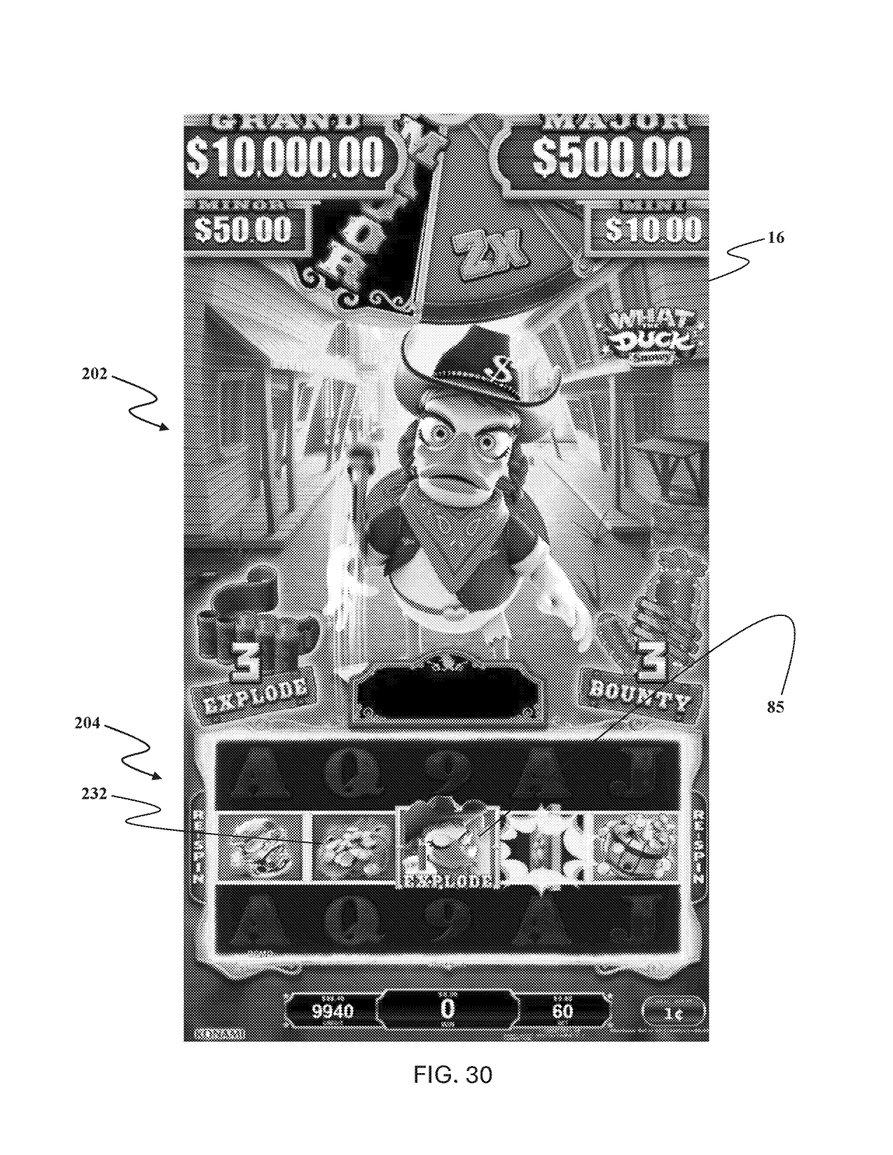

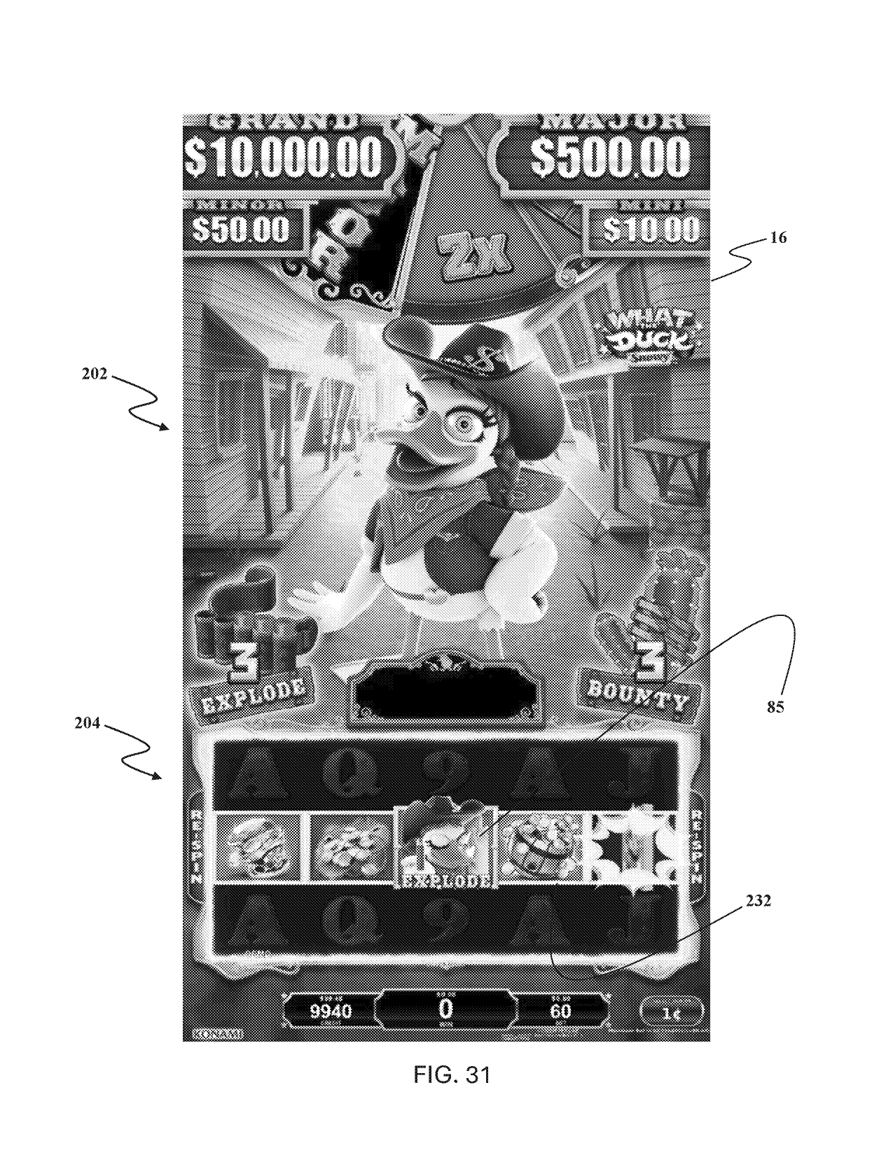

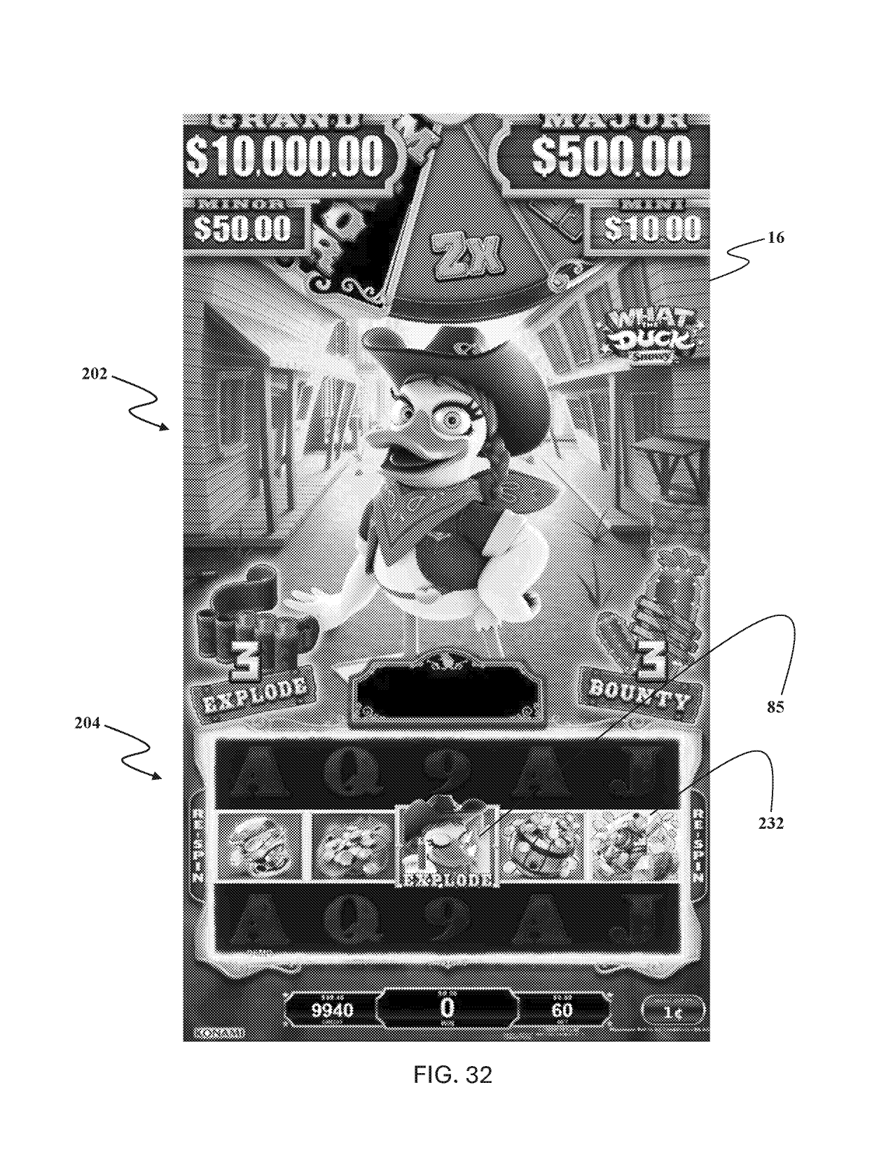

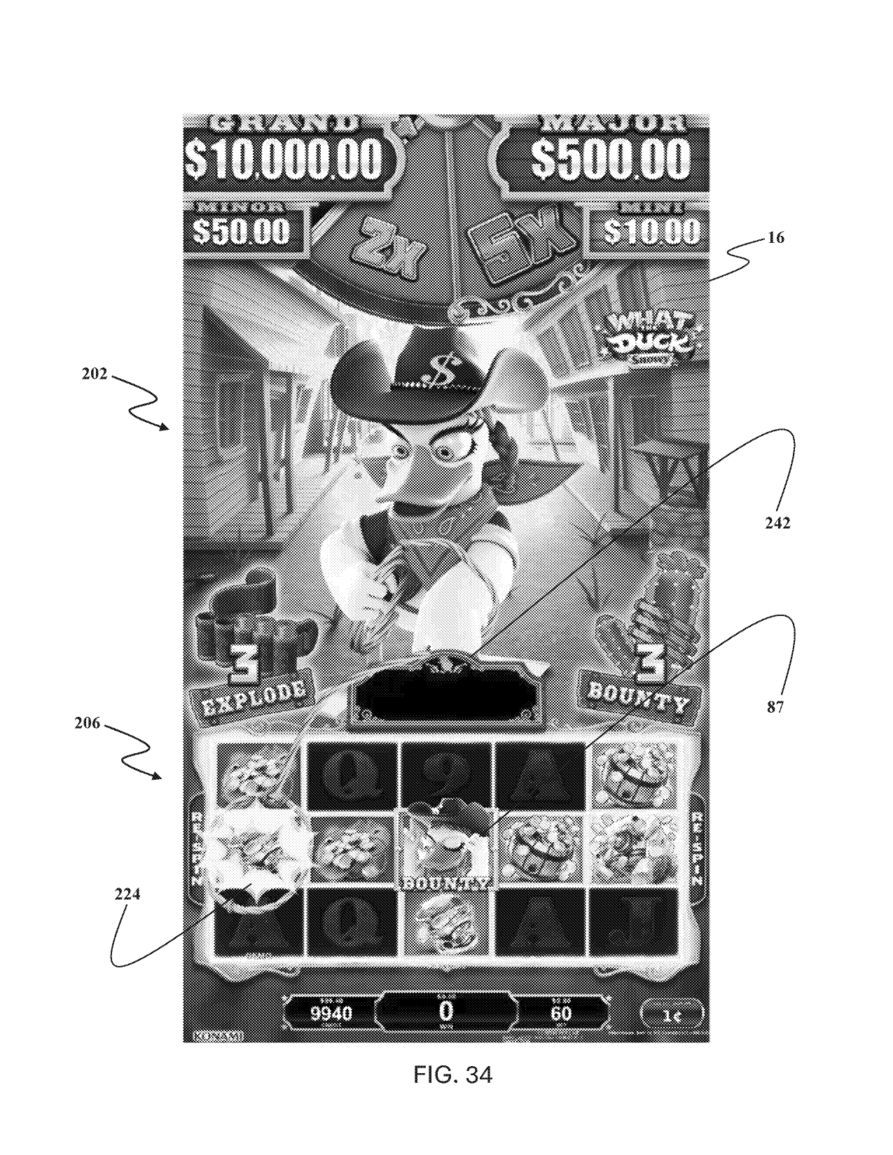

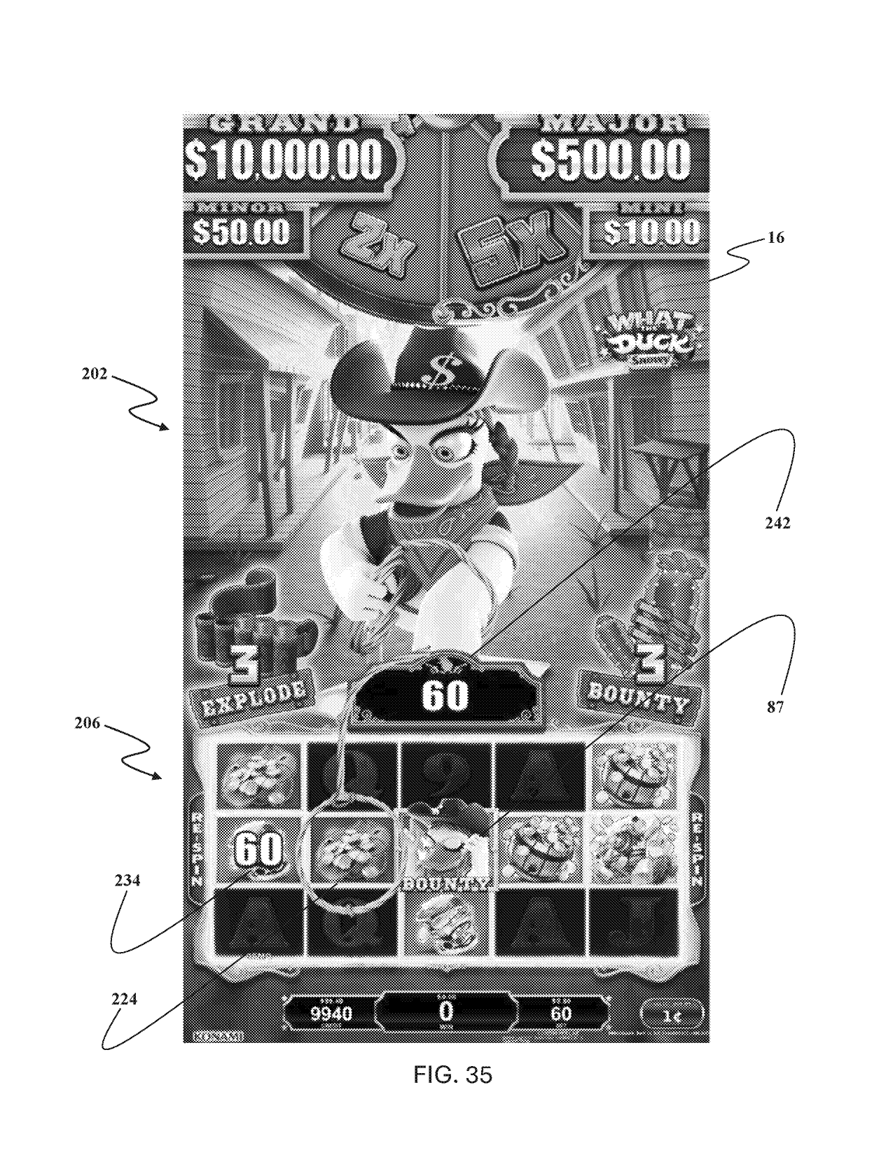

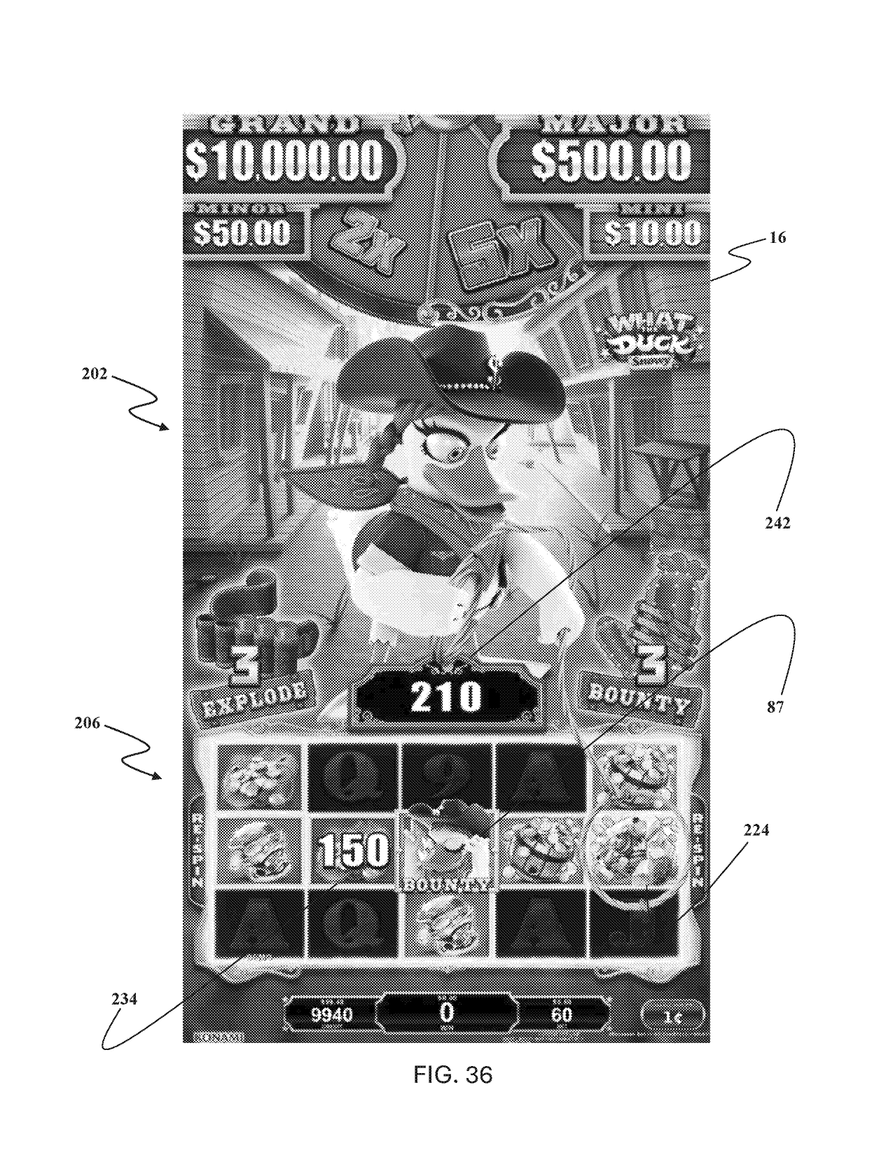

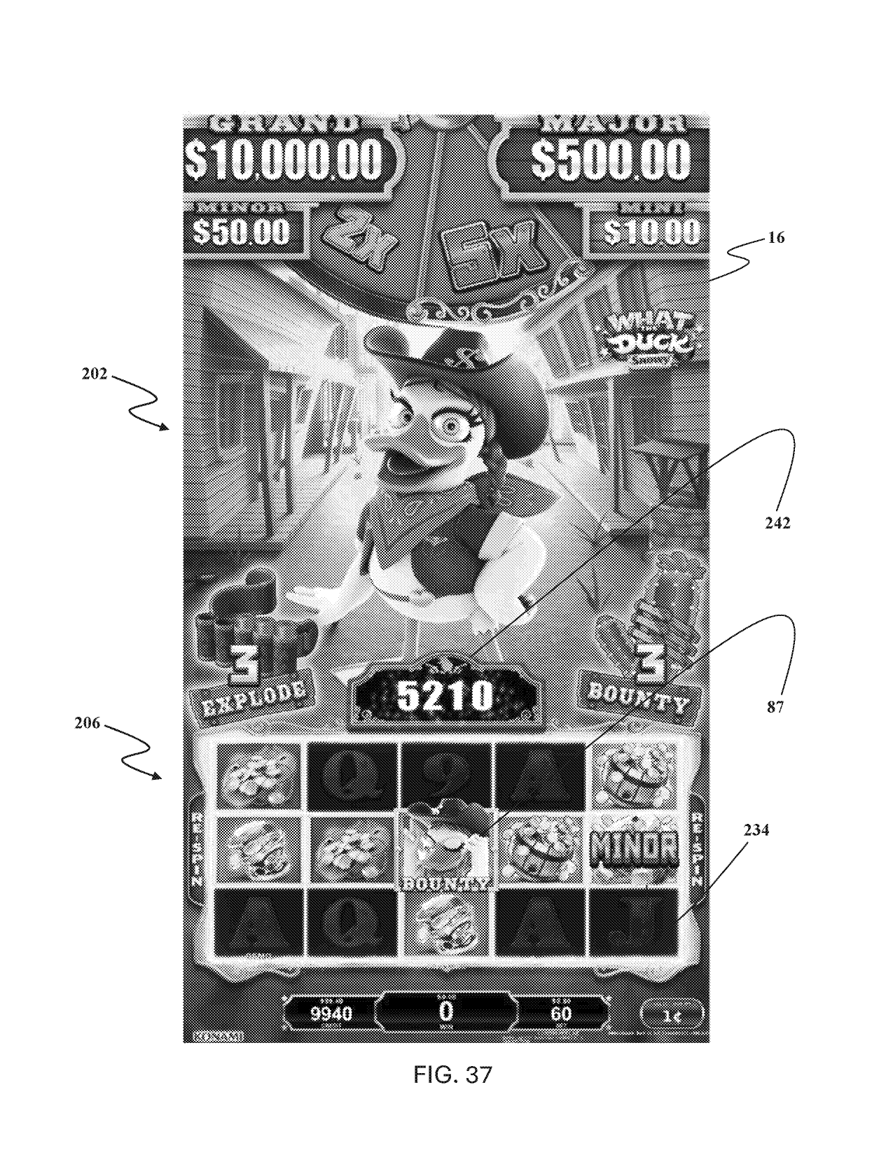

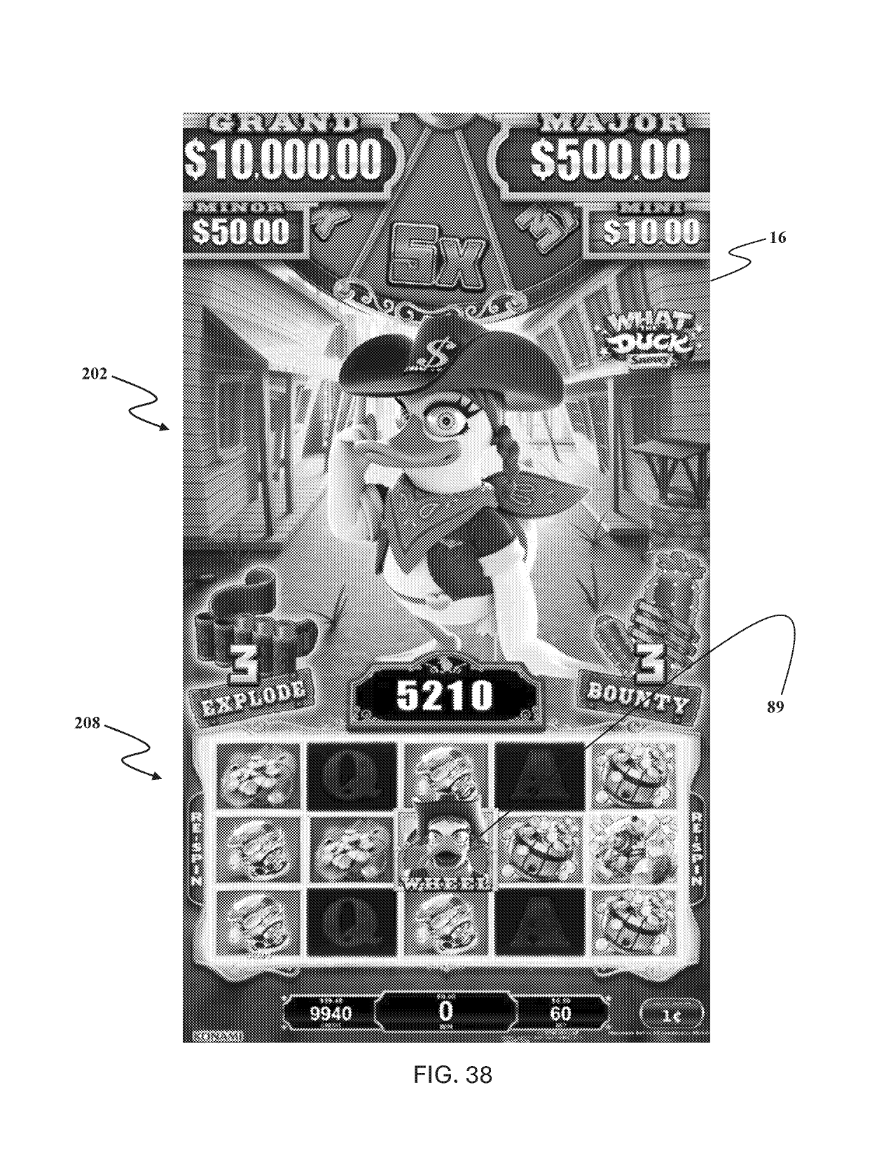

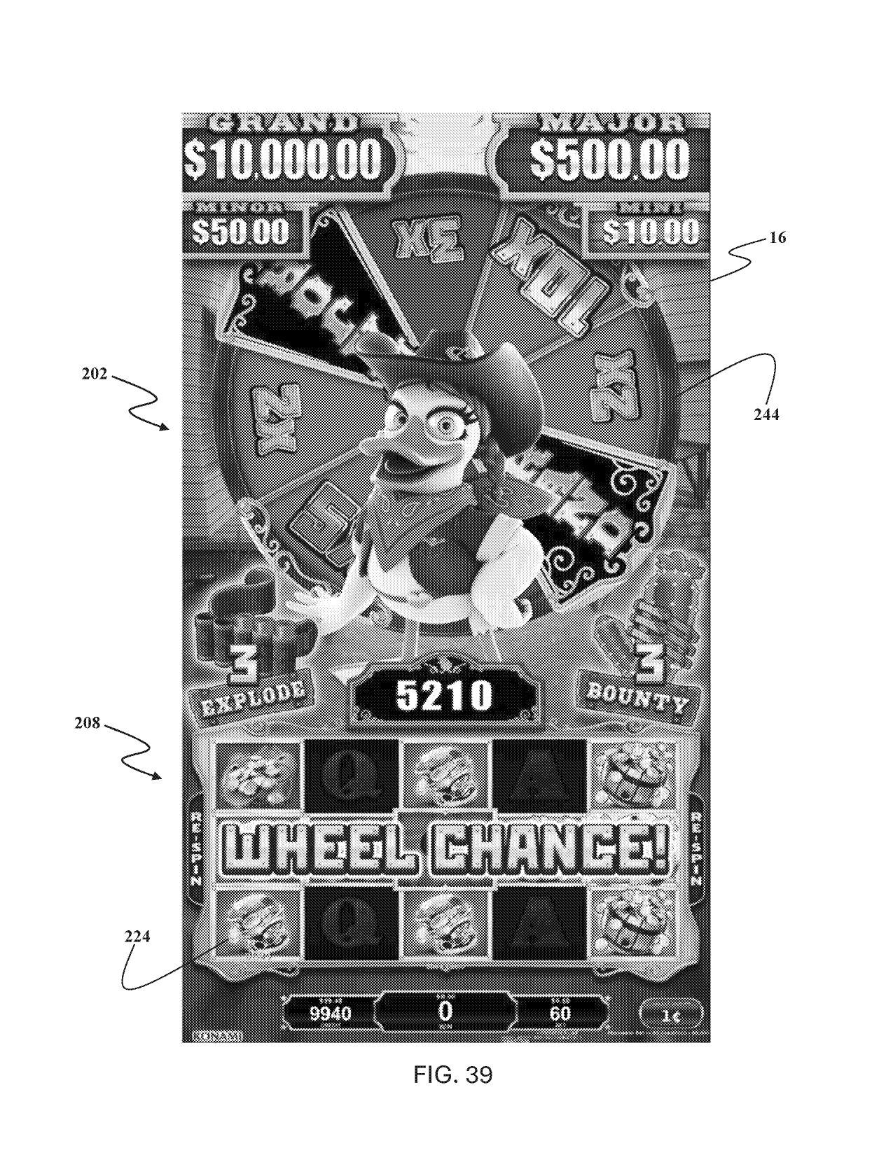

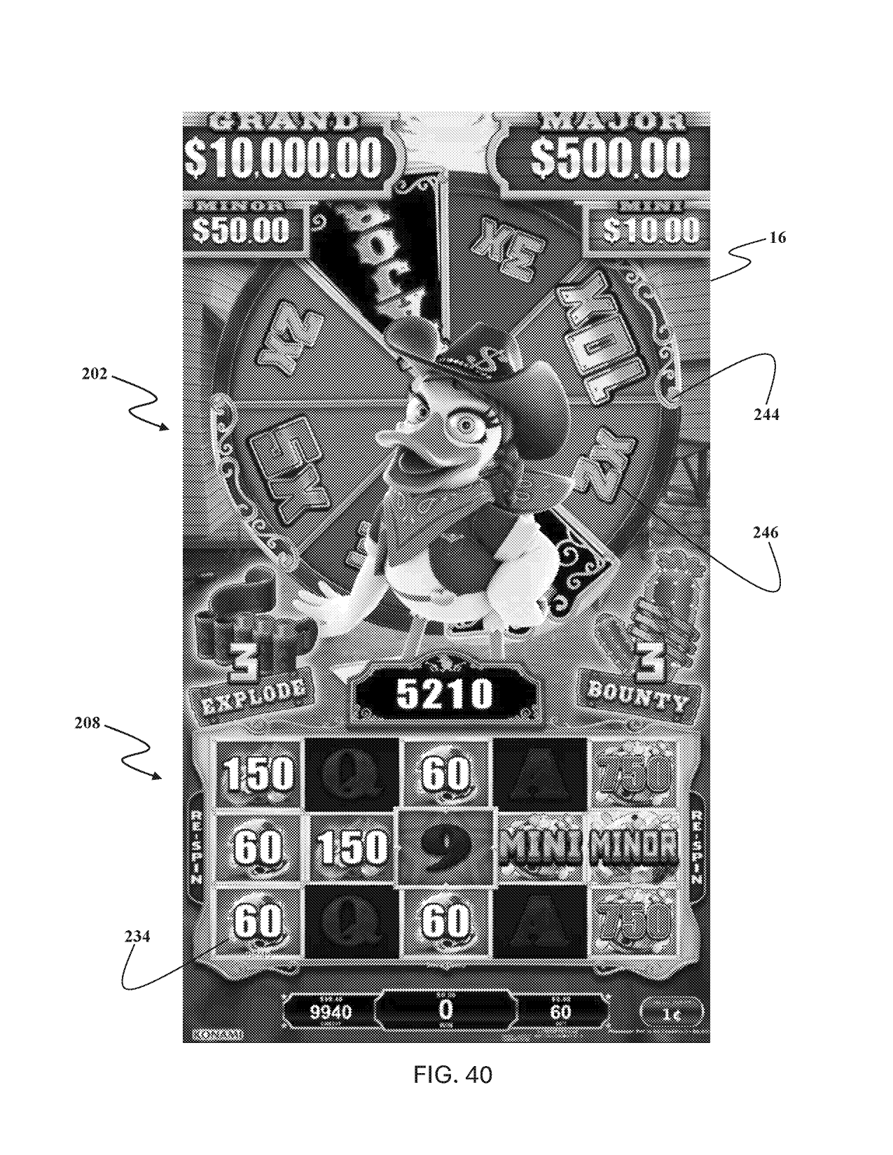

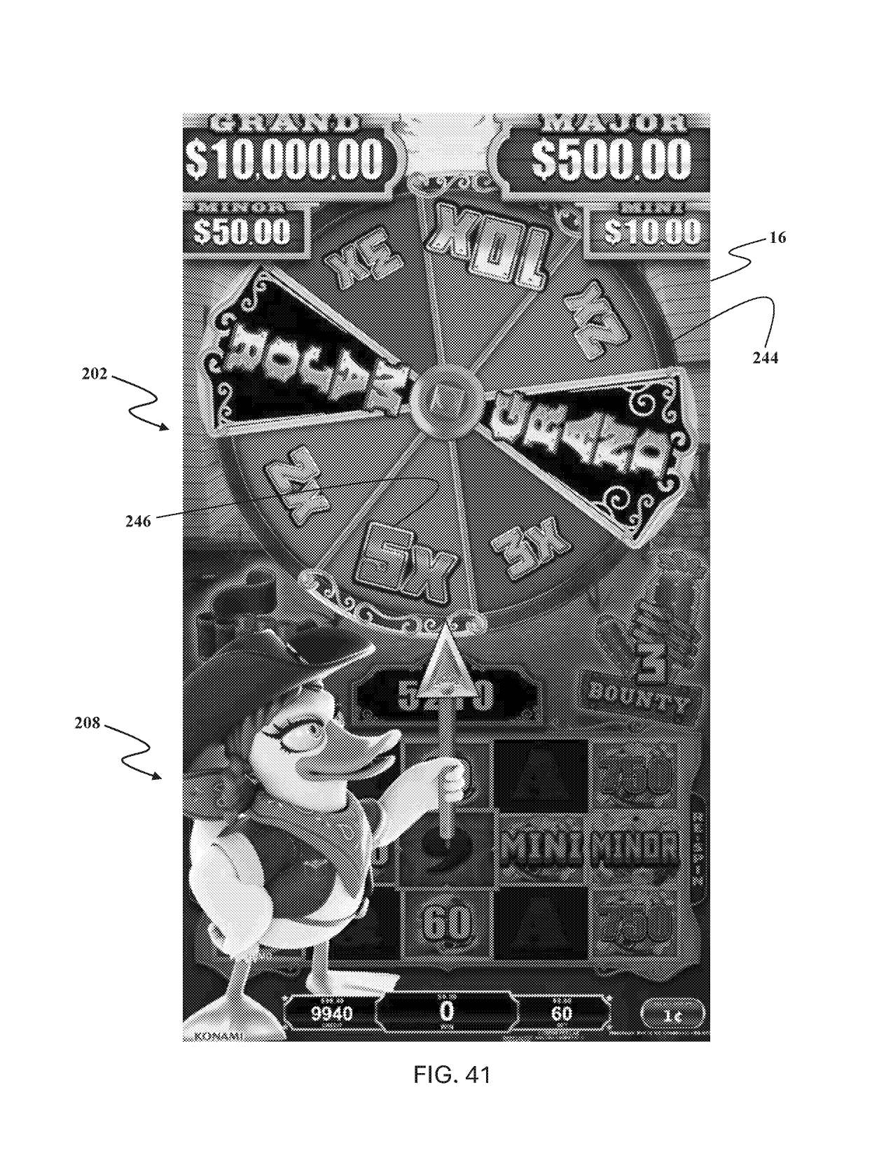

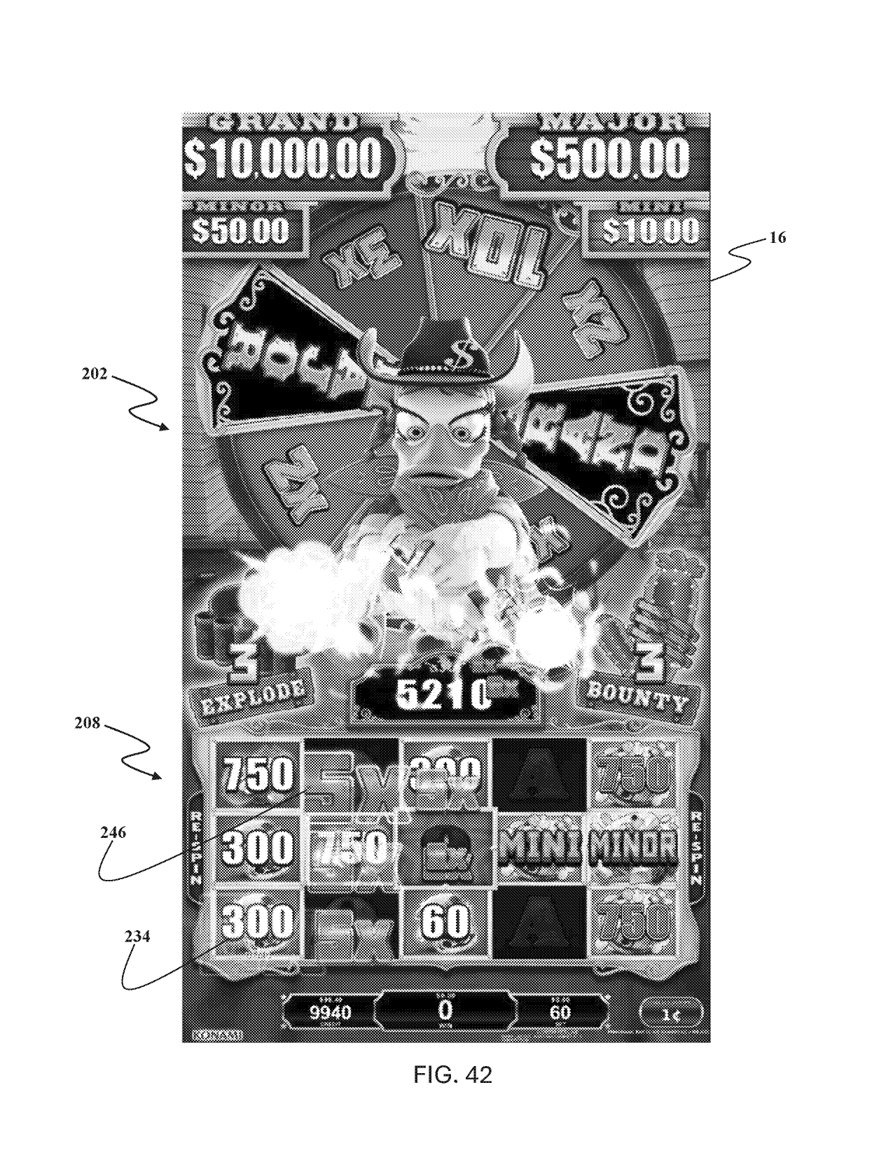

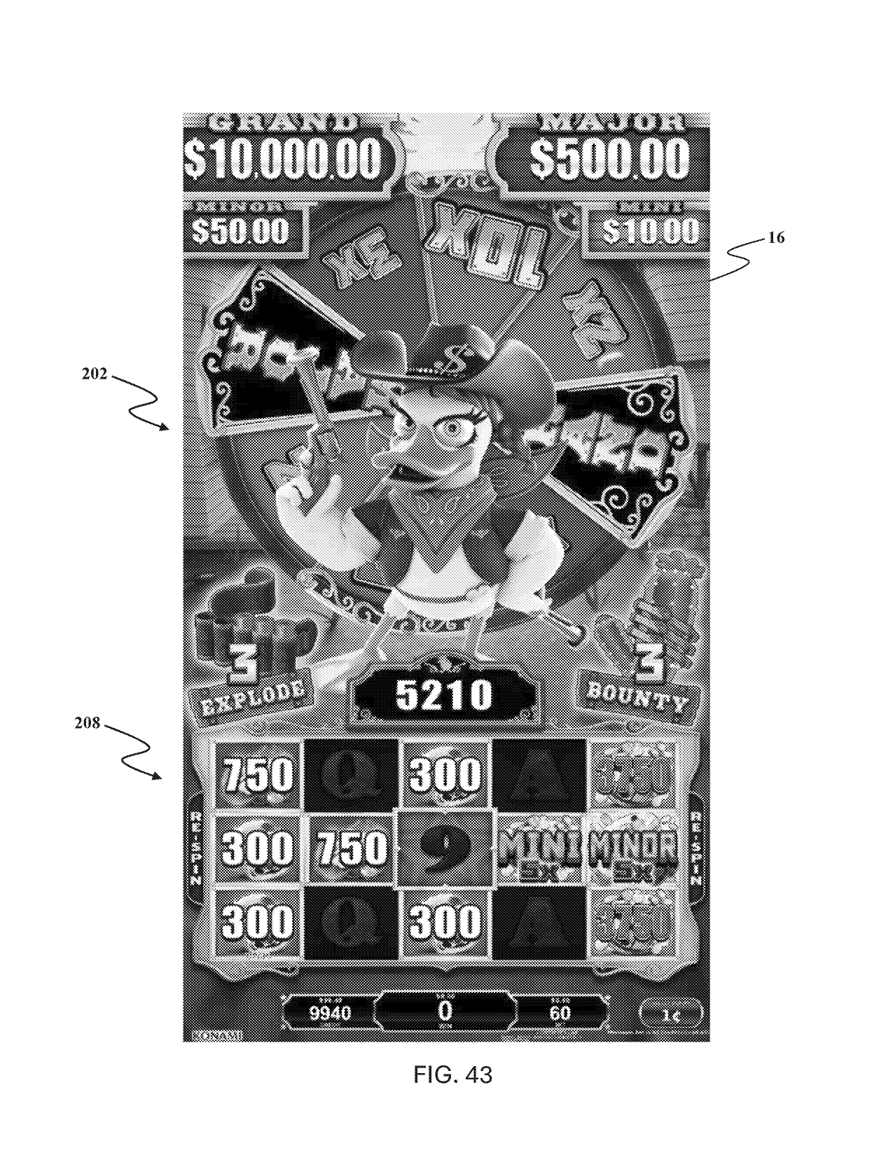

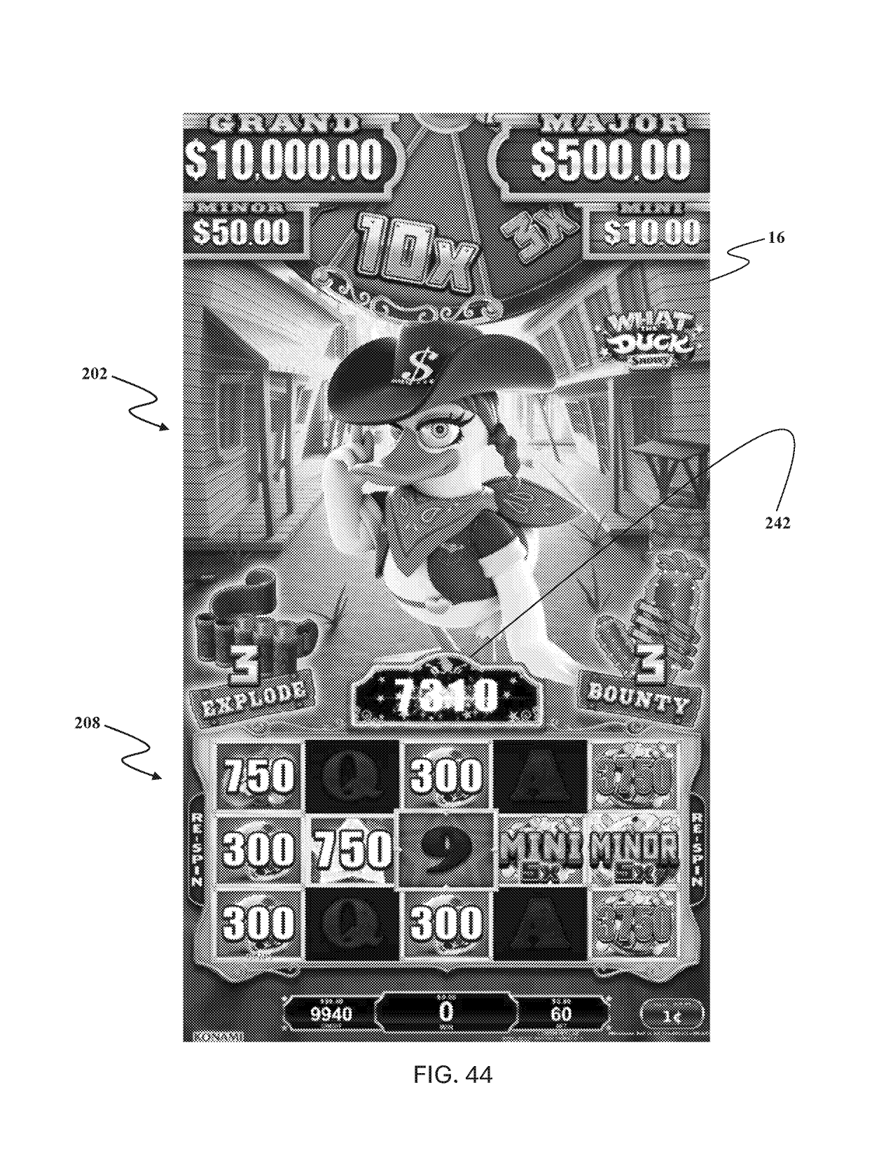

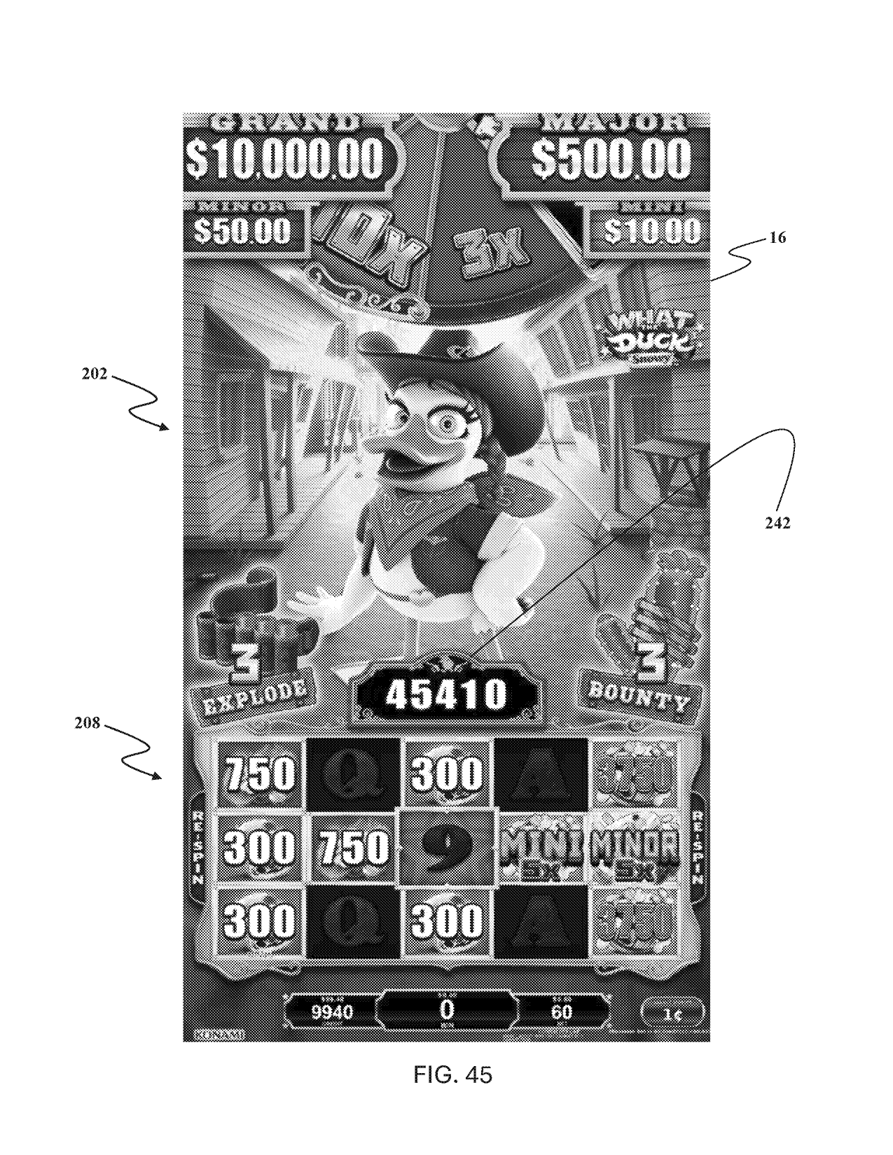

FIGS. 7A-11D and 25-45 are exemplary game screens of the computer-animated reel game illustrating the animation sequences displayed when executing algorithm 200. For example, FIGS. 9A-9D and 25-32 are exemplary game screens illustrating the first game feature as an Explode Action prize upgrade animation sequence 204 displayed when executing algorithm 200, FIGS. 10A-10D and 33-37 are exemplary game screens illustrating the second game feature as a Bounty Action prize reveal animation sequence 206 when executing algorithm 200, and FIGS. 38-45 are exemplary game screens illustrating the wheel game as a Wheel Chance animation sequence 208 displayed when executing algorithm 200. FIGS. 23 and 24 are illustrations of exemplary data lookup tables including a prize upgrade data lookup table 210 and a prize reveal data lookup table 212.

In step S10, the control unit 22 receives a game start operation by the player, and upon receiving an operation of the spin button from the player, subtracts the set total bet amount from the credit and acquires a predetermined number of random numbers required to provide the game. The random numbers are generated internally by the random number generator 108 of the control unit 22. The control unit 22 may acquire the random numbers from a random number generator provided separately from the control unit 22, or may be configured to acquire the random numbers from a device such as a server provided outside the gaming machine 10.

In step S12, the control unit 22 starts spinning a plurality of reels. Next, in step S14, the control unit 22 stops spinning the plurality of reels. In step S16, the control unit 22 determines whether the first special symbol 85 ("Wild-A") has stopped in a specific cell in the game result. For example, the control unit 22 determines whether the first special symbol 85 has stopped in the center cell.

If it is determined that the first special symbol 85 has stopped in the specific cell (step S16: YES), in step S18, the control unit 22 determines whether the acquired random number is within a predetermined range. If it is determined that the acquired random number is within the predetermined range (step S18: YES), in step S20, the control unit 22 increments the first feature count by one. If it is determined that the acquired random number is not within the predetermined range (step S18: NO), in step S22, the control unit 22 places a wild symbol in the specific cell. In this way, the first feature count increases with a certain probability when the first special symbol 85 stops.

If it is determined that the first special symbol 85 has not stopped in the specific cell (step S16: NO), if step S20 has ended, or if step S22 has ended, in step S24, the control unit 22 determines whether the second special symbol 87 ("Wild-B") has stopped in the specific cell. For example, the control unit 22 determines whether the second special symbol 87 has stopped in the center cell.

If it is determined that the second special symbol 87 has stopped in the specific cell (step S24: YES), in step S26, the control unit 22 determines whether the acquired random number is within a predetermined range. If it is determined that the acquired random number is within the predetermined range (step S26: YES), in step S28, the control unit 22 increments the second feature count by one. If it is determined that the acquired random number is not within the predetermined range (step S26: NO), in step S30, the control unit 22 places a wild symbol in the specific cell. In this way, the second feature count increases with a certain probability when the second special symbol 87 stops.

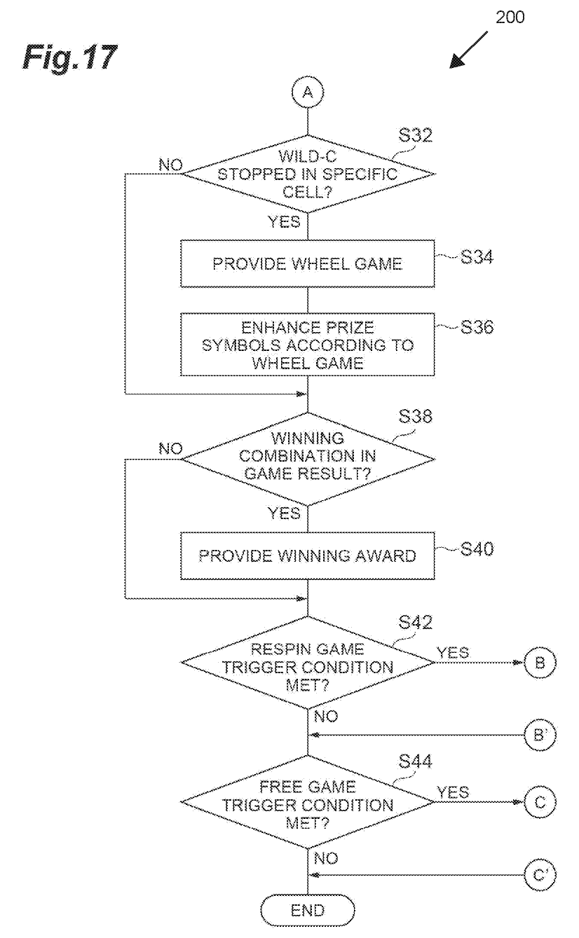

If it is determined that the second special symbol 87 has not stopped in the specific cell (step S24: NO), if step S28 has ended, or if step S30 has ended, as shown in FIG. 17, in step S32, the control unit 22 determines whether the third special symbol 89 ("Wild-C") has stopped in the specific cell. For example, the control unit 22 determines whether the third special symbol 89 has stopped in the center cell.

If it is determined that the third special symbol 89 has stopped in the specific cell (step S32: YES), in step S34, the control unit 22 provides a wheel game. The control unit 22 displays a wheel including "GRAND", "MAJOR", "10×", "5×", "3×", or "2×" in the region 65 above the symbol display region 64, and determines the award to be applied by drawing. In step S36, the control unit 22 applies the determined award to the prize symbols displayed in the game result and enhances the prize symbols.

If it is determined that the third special symbol 89 has not stopped in the specific cell (step S32: NO), or if step S36 has ended, in step S38, the control unit 22 finalizes the symbol combination as the game result and determines whether the symbol combination has a winning combination. If it is determined that there is a win (step S38: YES), in step S40, the control unit 22 provides an amount corresponding to the win as an award (normal win). For example, the control unit 22 adds the amount corresponding to the win to the held credit. If it is determined that there is no win (step S38: NO), no award is provided.

Subsequently, in step S42, the control unit 22 determines whether a bonus game (a respin game as an example) has been triggered. The control unit 22 determines that a bonus game has been triggered if a series of adjacent symbols is formed from the left end. As a specific example, the control unit 22 determines that a bonus game has been triggered if prize symbols have stopped in at least the first, second, and third columns.

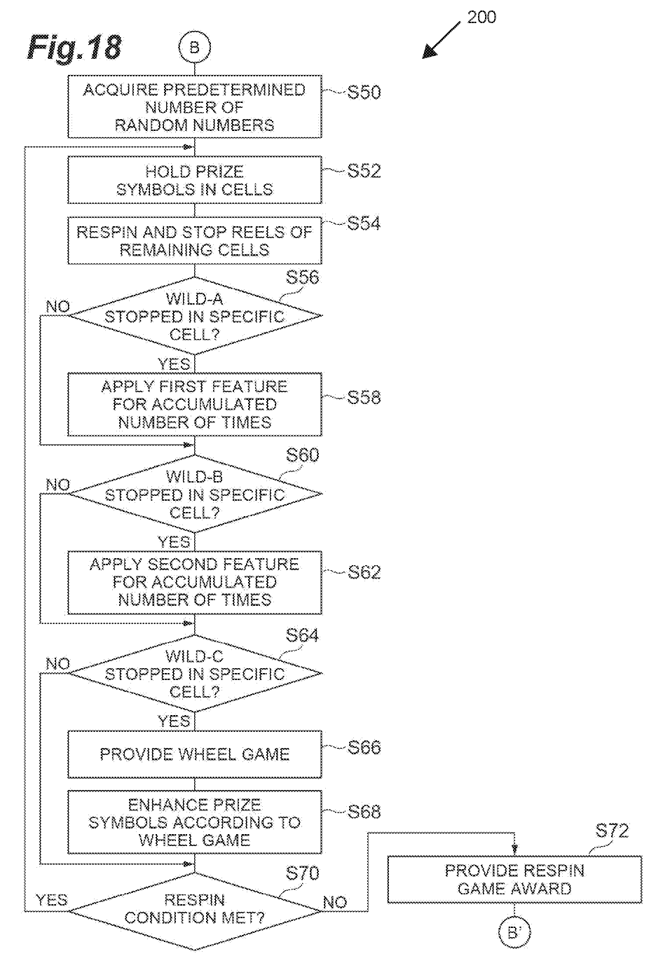

If it is determined that a bonus game has been triggered (step S42: YES), as shown in FIG. 18, in step S50, the control unit 22 acquires a predetermined number of random numbers required to provide the bonus game. This operation is the same as step S10.

Subsequently, in step S52, the control unit 22 holds the prize symbols in the cells. As a result, the prize symbols are fixedly displayed in the cells. Subsequently, in step S54, the control unit 22 respins and stops the reels of the remaining cells. The control unit 22 respins and stops the independent reels corresponding to the cells where prize symbols are not held.

Subsequently, in step S56, the control unit 22 determines whether the first special symbol 85 ("Wild-A") has stopped in the specific cell in the game result. For example, the control unit 22 determines whether the first special symbol 85 has stopped in the center cell.

If it is determined that the first special symbol 85 has stopped in the specific cell (step S56: YES), in step S58, the control unit 22 applies the first feature for the accumulated number of times (see FIG. 9C). As a result, prize symbols in a number corresponding to the accumulated number of times are upgraded.

If it is determined that the first special symbol 85 has not stopped in the specific cell (step S56: NO), or if step S58 has ended, in step S60, the control unit 22 determines whether the second special symbol 87 ("Wild-B") has stopped in the specific cell in the game result. For example, the control unit 22 determines whether the second special symbol 87 has stopped in the center cell.

If it is determined that the second special symbol 87 has stopped in the specific cell (step S60: YES), in step S62, the control unit 22 applies the second feature for the accumulated number of times (see FIG. 10C). As a result, the number of prize symbols corresponding to the accumulated number of times is converted to the corresponding credit amounts, and the total of these credit amounts is acquired.

If it is determined that the second special symbol 87 has not stopped in the specific cell (step S60: NO), or if step S62 has ended, in step S64, the control unit 22 determines whether the third special symbol 89 ("Wild-C") has stopped in the specific cell in the game result. For example, the control unit 22 determines whether the third special symbol 89 has stopped in the center cell.

If it is determined that the third special symbol 89 has stopped in the specific cell (step S64: YES), in step S66, the control unit 22 provides a wheel game. The control unit 22 displays a wheel including "GRAND", "MAJOR", "10×", "5×", "3×", or "2×" in the region 65 above the symbol display region 64, and determines the award to be applied by drawing. In step S68, the control unit 22 applies the determined award to the prize symbols displayed in the game result and enhances the prize symbols.

If it is determined that the third special symbol 89 has not stopped in the specific cell (step S64: NO), or if step S68 has ended, in step S70, the control unit 22 determines whether the condition for a respin is met. The control unit 22 determines that the condition for a respin is met if a new prize symbol connects to a series of adjacent symbols when the respun reel stops, that is, if a new prize symbol stops in a region including at least four adjacent columns from the left end.

If it is determined that the condition for a respin is met (step S70: YES), the control unit 22 returns to step S52. In this way, the control unit 22 repeatedly executes steps S52 to S70 until it is determined that the condition for a respin is not met.

If it is determined that the condition for a respin is not met (step S70: NO), in step S72, the control unit 22 provides the award of the respin game (award of the bonus game). When step S72 ends, the process returns to FIG. 17, and in step S44, the control unit 22 determines whether the trigger condition for a special game (free game) is met. The control unit 22 determines that the trigger condition is met, for example, when a predetermined number of scatter symbols appear in the game result of the normal game. Note that although the operation of determining whether the first to third special symbols 85, 87, 89 have stopped in the specific cell after the respin has been shown here, it is also possible to make the determination before the respin. For example, if the determination is made before the respin at the start of the bonus game, the game feature triggered at the start of the bonus game can be provided as shown in FIGS. 9A-9D and 10A-10D.

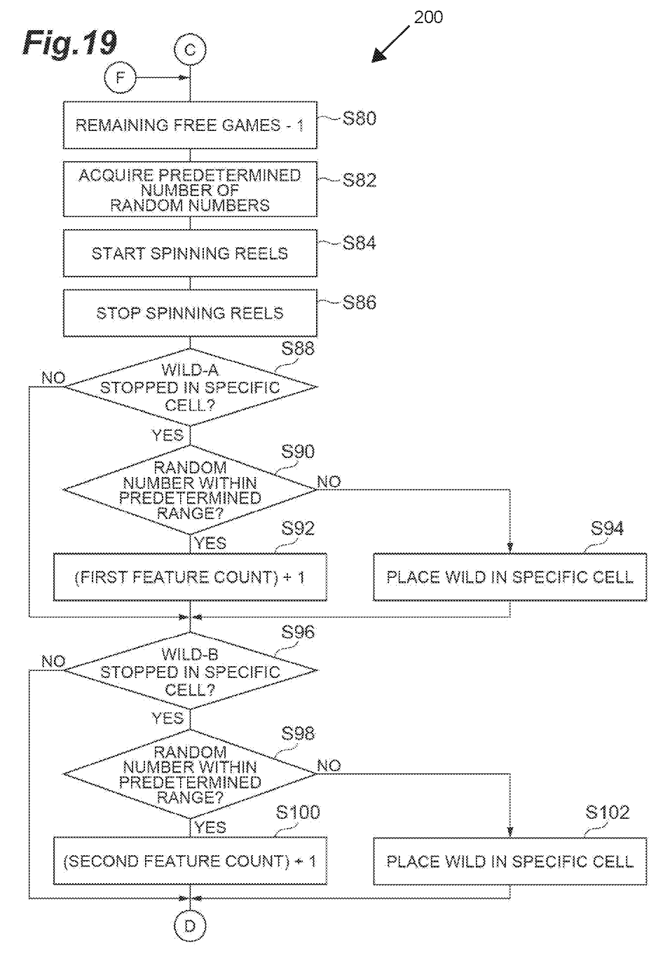

If it is determined that the trigger condition for a free game is met (step S44: YES), as shown in FIG. 19, in step S80, the control unit 22 decrements the remaining number of free games by one. Subsequently, in step S82, the control unit 22 acquires a predetermined number of random numbers required to provide the free game. This operation is the same as step S10.

In step S84, the control unit 22 starts spinning a plurality of reels. Next, in step S86, the control unit 22 stops spinning the plurality of reels. In step S88, the control unit 22 determines whether the first special symbol 85 ("Wild-A") has stopped in a specific cell in the game result. For example, the control unit 22 determines whether the first special symbol 85 has stopped in the center cell.

If it is determined that the first special symbol 85 has stopped in the specific cell (step S88: YES), in step S90, the control unit 22 determines whether the acquired random number is within a predetermined range. If it is determined that the acquired random number is within the predetermined range (step S90: YES), in step S92, the control unit 22 increments the first feature count by one. If it is determined that the acquired random number is not within the predetermined range (step S90: NO), in step S94, the control unit 22 places a wild symbol in the specific cell. In this way, the first feature count increases with a certain probability when the first special symbol 85 stops.

If it is determined that the first special symbol 85 has not stopped in the specific cell (step S88: NO), if step S92 has ended, or if step S94 has ended, in step S96, the control unit 22 determines whether the second special symbol 87 ("Wild-B") has stopped in the specific cell. For example, the control unit 22 determines whether the second special symbol 87 has stopped in the center cell.

If it is determined that the second special symbol 87 has stopped in the specific cell (step S96: YES), in step S98, the control unit 22 determines whether the acquired random number is within a predetermined range. If it is determined that the acquired random number is within the predetermined range (step S98: YES), in step S100, the control unit 22 increments the second feature count by one. If it is determined that the acquired random number is not within the predetermined range (step S98: NO), in step S102, the control unit 22 places a wild symbol in the specific cell. In this way, the second feature count increases with a certain probability when the second special symbol 87 stops.

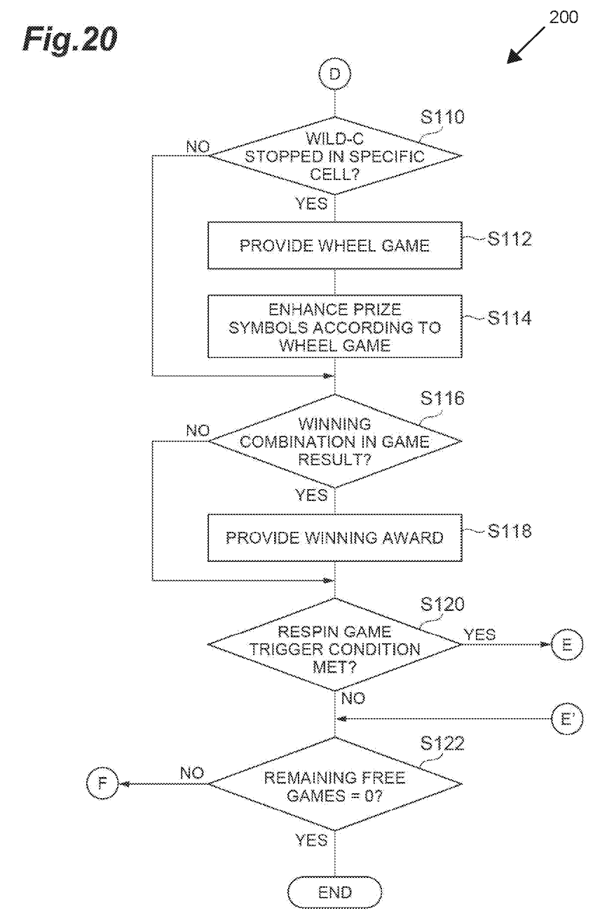

If it is determined that the second special symbol 87 has not stopped in the specific cell (step S96: NO), if step S100 has ended, or if step S102 has ended, as shown in FIG. 20, in step S110, the control unit 22 determines whether the third special symbol 89 ("Wild-C") has stopped in the specific cell. For example, the control unit 22 determines whether the third special symbol 89 has stopped in the center cell.

If it is determined that the third special symbol 89 has stopped in the specific cell (step S110: YES), in step S112, the control unit 22 provides a wheel game. The control unit 22 displays a wheel including "GRAND", "MAJOR", "10×", "5×", "3×", or "2×" in the region 65 above the symbol display region 64, and determines the award to be applied by drawing. In step S114, the control unit 22 applies the determined award to the prize symbols displayed in the game result and enhances the prize symbols.

If it is determined that the third special symbol 89 has not stopped in the specific cell (step S110: NO), or if step S114 has ended, in step S116, the control unit 22 finalizes the symbol combination as the game result and determines whether the symbol combination has a winning combination. If it is determined that there is a win (step S116: YES), in step S118, the control unit 22 provides an amount corresponding to the win as an award (normal win). For example, the control unit 22 adds the amount corresponding to the win to the held credit. If it is determined that there is no win (step S116: NO), no award is provided.

Subsequently, in step S120, the control unit 22 determines whether a bonus game (a respin game as an example) has been triggered. The control unit 22 determines that a bonus game has been triggered if a series of adjacent symbols is formed from the left end. As a specific example, the control unit 22 determines that a bonus game has been triggered if prize symbols have stopped in at least the first, second, and third columns.

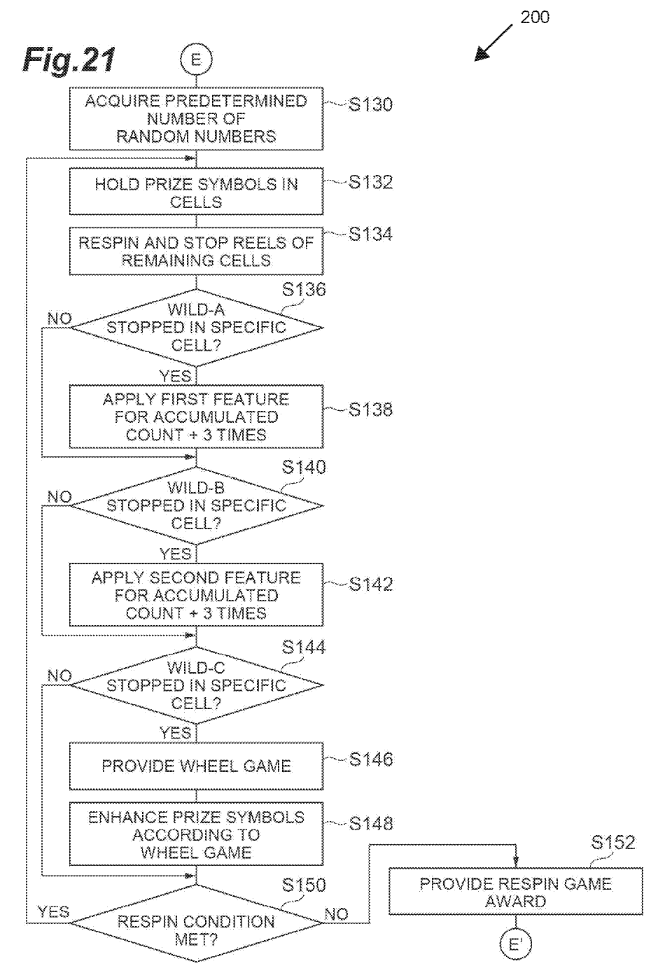

If it is determined that a bonus game has been triggered (step S120: YES), as shown in FIG. 21, in step S130, the control unit 22 acquires a predetermined number of random numbers required to provide the bonus game. This operation is the same as step S10.

Subsequently, in step S132, the control unit 22 holds the prize symbols in the cells. As a result, the prize symbols are fixedly displayed in the cells. Subsequently, in step S134, the control unit 22 respins and stops the reels of the remaining cells. The control unit 22 respins and stops the independent reels corresponding to the cells where prize symbols are not held.

Subsequently, in step S136, the control unit 22 determines whether the first special symbol 85 ("Wild-A") has stopped in the specific cell in the game result. For example, the control unit 22 determines whether the first special symbol 85 has stopped in the center cell.

If it is determined that the first special symbol 85 has stopped in the specific cell (step S136: YES), in step S138, the control unit 22 applies the first feature for the number of times obtained by adding the bonus count (e.g., three times) to the accumulated count. As a result, prize symbols in a number corresponding to the count obtained by adding the bonus count to the accumulated count are upgraded.

If it is determined that the first special symbol 85 has not stopped in the specific cell (step S136: NO), or if step S138 has ended, in step S140, the control unit 22 determines whether the second special symbol 87 ("Wild-B") has stopped in the specific cell in the game result. For example, the control unit 22 determines whether the second special symbol 87 has stopped in the center cell.

If it is determined that the second special symbol 87 has stopped in the specific cell (step S140: YES), in step S142, the control unit 22 applies the second feature for the number of times obtained by adding the bonus count (e.g., three times) to the accumulated count. As a result, the number of prize symbols corresponding to the number of times obtained by adding the bonus count to the accumulated count is converted to the corresponding credit amounts, and the total of these credit amounts is acquired.

If it is determined that the second special symbol 87 has not stopped in the specific cell (step S140: NO), or if step S142 has ended, in step S144, the control unit 22 determines whether the third special symbol 89 ("Wild-C") has stopped in the specific cell in the game result. For example, the control unit 22 determines whether the third special symbol 89 has stopped in the center cell.

If it is determined that the third special symbol 89 has stopped in the specific cell (step S144: YES), in step S146, the control unit 22 provides a wheel game. The control unit 22 displays a wheel including "GRAND", "MAJOR", "10×", "5×", "3×", or "2×" in the region 65 above the symbol display region 64, and determines the award to be applied by drawing. In step S148, the control unit 22 applies the determined award to the prize symbols displayed in the game result and enhances the prize symbols. Note that although the operation of determining whether the first to third special symbols 85, 87, 89 have stopped in the specific cell after the respin has been shown here, it is also possible to make the determination before the respin.

If it is determined that the third special symbol 89 has not stopped in the specific cell (step S144: NO), or if step S148 has ended, in step S150, the control unit 22 determines whether the condition for a respin is met. The control unit 22 determines that the condition for a respin is met if a new prize symbol connects to a series of adjacent symbols when the respun reel stops, that is, if a new prize symbol stops in a region including at least four adjacent columns from the left end.

If it is determined that the condition for a respin is met (step S150: YES), the control unit 22 returns to step S132. In this way, the control unit 22 repeatedly executes steps S132 to S150 until it is determined that the condition for a respin is not met.

If it is determined that the condition for a respin is not met (step S150: NO), in step S152, the control unit 22 provides the award of the respin game (award of the bonus game).

When step S152 ends, the process returns to FIG. 17, and the series of flowcharts ends. If it is determined that the trigger condition for a free game is met (step S44: YES), the series of flowcharts also ends.

As described above, in the gaming machine 10, the feature count is accumulated when a special symbol is included in the game result in the normal game. Then, in response to a bonus event occurring in the result of the normal game and a feature event occurring in the result of the bonus game, game features for the accumulated feature count are provided. When an event that triggers a special game occurs in the normal game, the special game is provided for a predetermined number of times, and the number of times the special symbol has appeared in the result of the special game is further added to the feature count. Then, in response to a bonus event occurring in the result of the special game and a feature event occurring in the result of the bonus game, game features for the number of times obtained by adding a predetermined number of times to the accumulated feature count are provided. In this way, the number of times the game features are provided is greater when a feature event occurs in the special game than when a feature event occurs in the normal game. Therefore, it is possible to increase the player's anticipation for the special game. Thus, the gaming machine 10 can provide a special game that is more advantageous than the normal game. In other words, the gaming machine 10 provides players with an excellent user experience by offering special games (free games) with higher added value than conventional gaming machines, achieved through the specific configuration of the aforementioned game mechanics.

In some embodiments, the one or more processors of the CPU 38 are programmed to execute algorithm 200 to display an animated sequence of computer-generated images of the computer-animated reel game 202 on the graphical user interface (GUI) of display device 16. For example, the CPU 38 is programmed to render the game screen on the display device GUI 16 including the grid 68 having a plurality of cells 70 arranged in a three row by five column (3x5) matrix. A prize upgrade symbol meter 214 displaying a number of collected prize upgrade symbols (e.g. the first special symbol 85 ("Wild-A") and a prize reveal symbol meter 216 displaying a number of collected prize reveal symbols (e.g. the second special symbol 87 ("Wild-B")) is rendered above the grid 68.

The CPU 38 is also programmed to render a plurality of individual reels 218 (e.g. virtual reel strips 72A, 72B, 72C, 74A, 74B, 74C, 76A, 76B, 76C, 78A, 78B, 78C, 80A, 80B, and 80C) within the grid 68 displaying a plurality of game symbols. The plurality of individual reels 218 includes a plurality of prize reels 220 and a bonus feature reel 222. Each prize reel 220 displays a plurality of prize symbols 224 (e.g. CR1-CR4) and a plurality of non-prize symbols 226 (e.g. card symbols "J", "Q", "K", and "A", and picture symbols "Pic-A", "Pic-B", "Pic-C", "Pic-D", and "Pic-E"). The bonus feature reel 222 displays a prize upgrade symbol 85, a prize reveal symbol 87, a wheel chance symbol (e.g. the third special symbol 89 ("Wild-C")), and a plurality of non-prize symbols 226.

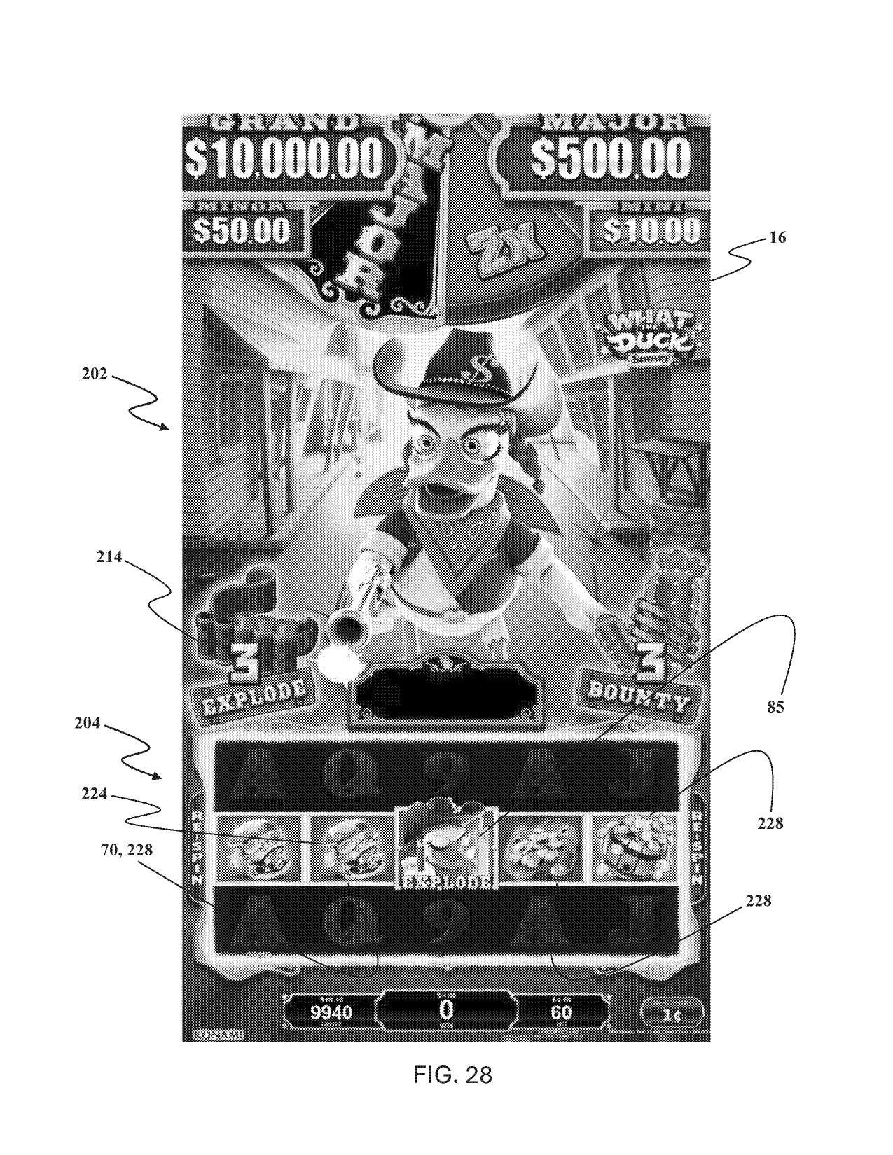

The CPU 38 then initiates a spin of the reel game by animating the plurality of individual reels 218 to spin and stop to display the game symbols within the grid 68 including one or more prize symbols 224 and the prize upgrade symbol 85. Upon detecting the prize upgrade symbol 85 appearing the grid 68 when the individual reels 218 are stopped, the CPU 38 then initiates the prize upgrade animation sequence 204 shown in FIGS. 28-32. For example, the CPU 38 may render the bonus feature reel 222 within a center cell positioned within a middle row and a third column of the 3x5 matrix, and initiate the prize upgrade animation sequence 204 when the bonus feature reel 222 spins and stops to display the prize upgrade symbol 85.

The CPU 38 then initiates the prize upgrade animation sequence 204 by randomly selecting a number of cells 228 displaying prize symbols 224 based on the number of collected prize upgrade symbols 85 currently included in the prize upgrade symbol meter 214 using the random number generator 108, and determining a type of prize symbol being displayed in each selected cell 228. The CPU 38 then accesses the prize upgrade data lookup table 210 which includes computer-executable instructions for replacing current prize symbols with upgraded prize symbols. The prize upgrade data lookup table 210 includes a plurality of upgrade data files 230 that each include a current prize symbol images 224 and an associated upgraded prize symbol image 232. For example, the prize upgrade data lookup table 210 may include upgrade data files 230 that include current prize symbol CR1 associated with upgrade prize symbol CR2, current prize symbol CR2 associated with upgrade prize symbol CR3, and current prize symbol CR3 associated with upgrade prize symbol CR4.

The CPU 38 accesses the prize upgrade data lookup table 210, determines an upgrade prize symbol 232 associated with each type of prize symbol being displayed in each selected cell 228, and sequentially animates each associated upgrade prize symbol 232 to replace a corresponding prize symbol 224 displayed in each selected cell 228.

When the prize upgrade animation sequence 204 is completed, the CPU 38 may also be programmed to initiate a subsequent spin of the reel game by holding each prize reel 220 currently displaying a prize symbol 224 in place, while animating each other prize reel 220 displaying a non-prize symbol 226 and the bonus feature reel 222 to spin, and stopping the spinning prize reels 220 and the bonus feature reel 222 to display one or more additional prize symbols 224 and the prize reveal symbol 87.

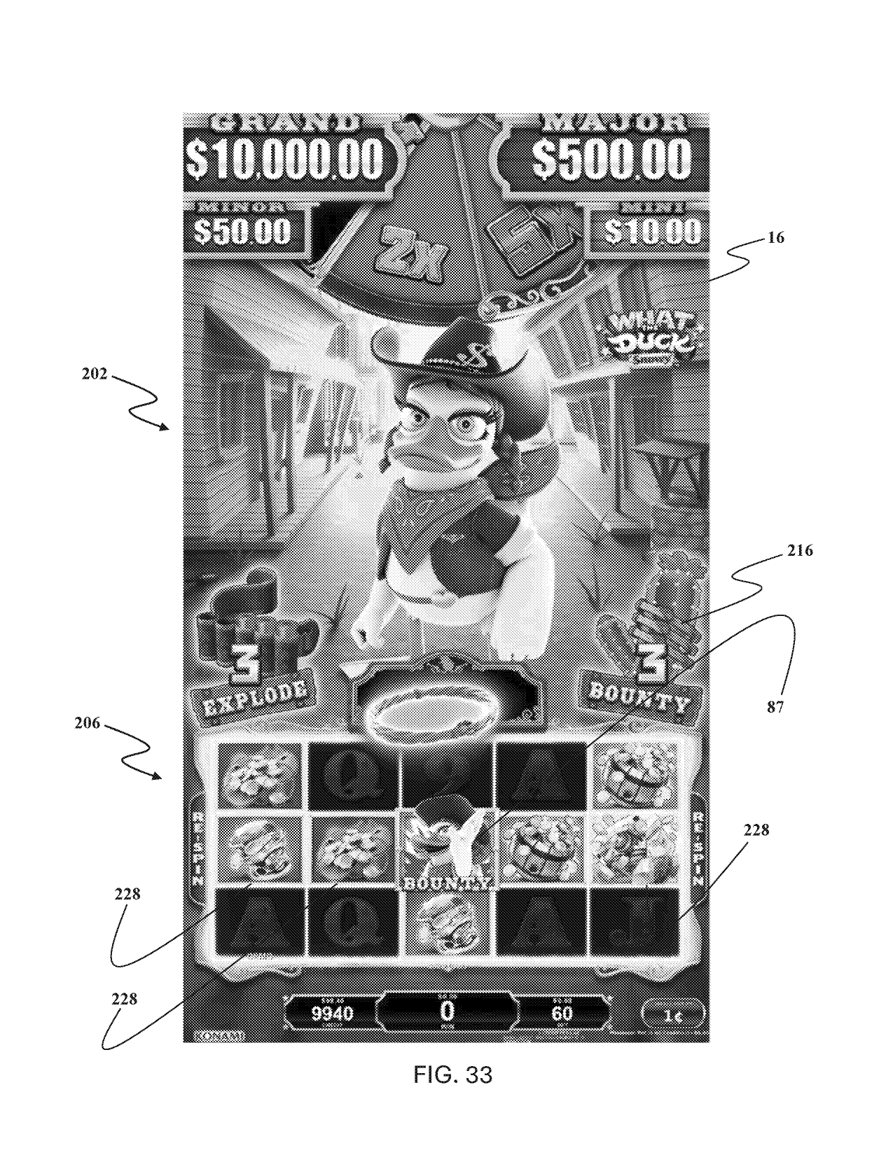

Upon detecting the prize reveal symbol 87 appearing the grid 68 when the individual reels 218 are stopped, the CPU 38 then initiates the prize reveal animation sequence 206 shown in FIGS. 33-37.

The CPU 38 initiates the prize reveal animation sequence 206 by randomly selecting a second number of cells 228 displaying prize symbols 224 based on the number of collected prize reveal symbols 87 included in the prize reveal symbol meter 216 using the random number generator, determining a type of prize symbol 224 being displayed in each selected cell 228, accessing the prize reveal data lookup table 212 to determine a plurality of credit prize values 234 associated with each type of prize symbol 224 being displayed in each selected cell 228, and randomly selecting a credit prize value 234 from the associated plurality of credit prize values 234 associated for each prize symbol 224 being displayed in each selected cell 228 using the random number generator 108.

For example, the prize reveal data lookup table 212 includes computer-executable instructions for selecting credit prize values 234 and animating credit prize values 234 to overlay corresponding prize symbols 224. The prize reveal data lookup table 212 includes a plurality of prize reveal data files 236 that each include a type of prize symbol 224 and a plurality of credit prize values 234 associated with the corresponding type of prize symbol 224. Each credit prize values 234 is associated with a selection probability 238 and a bet level 240.

For each selected cell 228, the CPU 38 determines the type of prize symbol 224 being displayed in each selected cell 228, accesses the prize reveal data lookup table 212 and determines the prize reveal data file 236 associated with the type of prize symbol 224 being displayed in the selected cell 228. The CPU 38 then randomly selects a credit prize value 234 from the associated plurality of credit prize values 234 based on corresponding selection probabilities 238 using the random number generator 108. The CPU 38 may also select a credit prize value 234 based on bet level 240.

Upon selecting a credit prize value 234 for each prize symbol 224 being displayed in each selected cell 228, the CPU 38 then sequentially animates each selected credit prize value 234 to overlay each corresponding prize symbol 224 displayed in each selected cell 228.

The CPU 38 may also be programmed to display a credit meter 242 above the grid 68 displaying an amount of credits indicating the current credit balance. As the CPU 38 sequentially animates each selected credit prize value 234 to overlay each corresponding prize symbol 224, the CPU 38 may also increase the amount of credits being displayed in the credit meter 242 based on each selected credit prize value 234 as each selected credit prize value 234 is overlayed over each corresponding prize symbol 224. The CPU 38 may also remove each selected credit prize value 234 from the grid 68 after increasing the amount of credits displayed in the credit meter 242.

When the prize upgrade animation sequence 204 is completed and/or the prize reveal animation sequence 206 is completed, the CPU 38 may be programmed to initiate another subsequent spin of the reel game by holding each prize reel 220 displaying a prize symbol 224 in place while animating each prize reel 220 displaying a non-prize symbol 226 and the bonus feature reel 222 to spin, and stopping the spinning prize reels 220 to display one or more additional prize symbols 224 and stopping the bonus feature reel 222 to display the wheel chance symbol 89.

Upon detecting the wheel chance symbol 89 appearing the grid 68 when the individual reels 218 are stopped, the CPU 38 then initiates the wheel chance animation sequence 208 shown in FIGS. 38-45.

The CPU 38 initiates the wheel chance animation sequence 208 by animating a wheel 244 to appear above the grid 68 including a plurality of multiplier values 246. The CPU 38 then accesses the prize reveal data lookup table 212 to determine the plurality of credit prize values 234 associated with each type of prize symbol 224 being displayed, randomly selects a second credit prize value 234 from the associated plurality of credit prize values 234 associated with each prize symbol 224 being displayed using the random number generator 108, and animates each selected second credit prize value 234 to overlay each corresponding prize symbol 224 being displayed in the grid 68. For example, the CPU 38 may sequentially animate each second credit prize value 234 to overlay each corresponding prize symbol 224 in a sequential order by displaying a lowest credit prize value first and displaying a highest credit prize value last.

The CPU 38 then randomly selects a multiplier value 246 being displayed on the wheel 244 using the random number generator 108, and animates the wheel 244 to rotate and stop to identify the randomly selected multiplier value 246.

The CPU 38 then animates images of the randomly selected multiplier value 246 to cascade down into the grid 68 to overlay each second credit prize value 234 and modify each second credit prize value 234 to increase based on the randomly selected multiplier value 246, and increases the amount of credits being displayed in the credit meter 242 based on each modified second credit prize value 234.

The gaming machine 10 may be a client computing device, in which case the game is delivered from a network server computer system to one or more client computing devices via a communication network. The processor of the client computing device may be programmed to function as the control unit 22 of the gaming machine 10.

When the gaming machine 10 is used as a client computing device, (1) a rich client system may be used in which most of the processing involved in game execution is performed on the client side and results are transmitted to the server, (2) a thin-client system may be used in which only minimum processing is performed on the client side and main processing is performed on the server side, and (3) a zero client system may be used in which most of data storage and processing is performed on the server side and the client specializes in input and output. In this case, the software configuration described in the embodiment is distributed and implemented in the client and the server.

In the above-described embodiment, an example was described in which the special game is a free game of a slot game, but the special game may be a slot game with a different matrix, a slot game with different rules, a respin game, a hold-and-spin game, a pick game, a roulette game, a card game, a dice game, or the like.

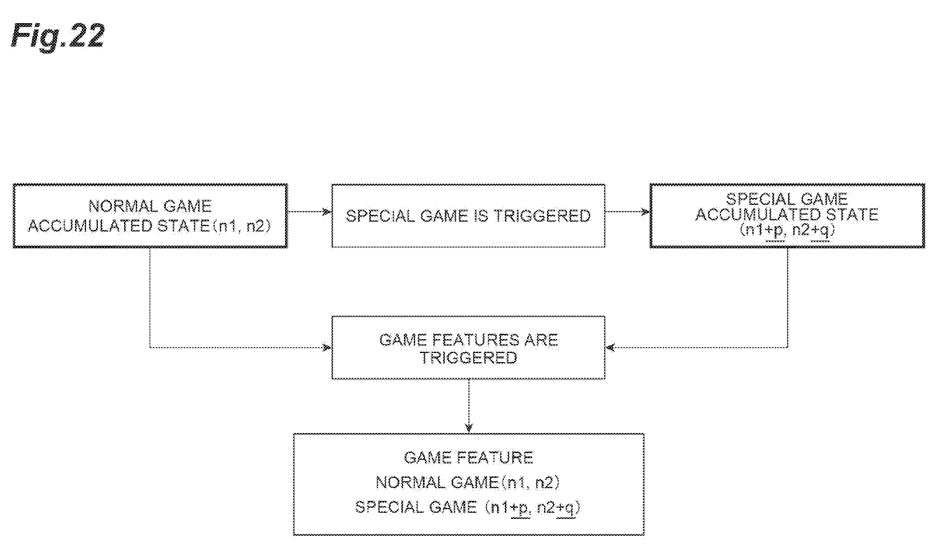

Although a bonus game exists in the above-described embodiment, the bonus game may be omitted. FIG. 22 is a diagram showing the relationship between a normal game and a special game. As shown in FIG. 22, it may be configured such that a feature event occurs in the normal game and the special game. For example, by accumulating special symbols in the normal game, a first feature count n1 and a second feature count n2 are set, and when a feature event (a condition other than the appearance of a special symbol) occurs, the first game feature for the first feature count n1 and the second game feature for the second feature count n2 are provided. Similarly, by accumulating special symbols in the special game, a first feature count n1 and a bonus count p, and a second feature count n2 and a bonus count q are set, and when a feature event (a condition other than the appearance of a special symbol) occurs, the first game feature for the number of times obtained by adding the bonus count p to the first feature count n1, and the second game feature for the number of times obtained by adding the bonus count q to the second feature count n2 are provided. Even with this configuration, it is possible to provide a special game that is more advantageous than the normal game.

The function of the control unit 22 of the gaming machine 10 described above can also be realized by a computer executing a program. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of a win are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there is a power anomaly. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game does not proceed after power restoration. However, by collectively acquiring all random numbers at the start of the game and storing these numbers in the memory 42 or the storage 44 as described above, it is possible to reproduce the game's progress similar to that before the power source abnormality occurred, after power recovery. This way, such a problem can be avoided.

Additionally, in the described embodiment, a bill or a ticket represents the game value. The bill or ticket is received by a bill/ticket identification unit6, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A gaming machine for displaying a computer-animated reel game, comprising:
a gaming cabinet;
a display device mounted to the cabinet and including a graphical user interface (GUI) display screen displaying computer-generated images thereon; and
a control unit operably coupled to the display device, the control unit including a random number generator and one or more processors programmed to execute an algorithm to display an animated sequence of computer-generated images of the computer-animated reel game on the display device GUI including the steps of:
rendering a game screen on the display device GUI including a grid having a plurality of cells arranged in a three row by five column (3x5) matrix, a prize upgrade symbol meter displaying a number of collected prize upgrade symbols, and a prize reveal symbol meter displaying a number of collected prize reveal symbols;
rendering a plurality of individual reels within the grid displaying a plurality of game symbols, the plurality of individual reels including a plurality of prize reels and a bonus feature reel, each prize reel displaying a plurality of prize symbols and a plurality of non-prize symbols, the bonus feature reel displaying a prize upgrade symbol, a prize reveal symbol, a wheel chance symbol, and a plurality of non-prize symbols;
initiating a spin of the reel game by animating the plurality of individual reels to spin and stop to display the game symbols within the grid including one or more prize symbols and the prize upgrade symbol;
initiating a prize upgrade animation sequence by:
randomly selecting a number of cells displaying prize symbols based on the number of collected prize upgrade symbols included in the prize upgrade symbol meter using the random number generator;
determining a type of prize symbol being displayed in each selected cell;
accessing a prize upgrade data lookup table to determine an upgrade prize symbol associated with each type of prize symbol being displayed in each selected cell; and
sequentially animating each associated upgrade prize symbol to replace a corresponding prize symbol displayed in each selected cell.

2. The gaming machine of claim 1, wherein the one or more processors is programmed to execute the algorithm including the steps of:
rendering the bonus feature reel with a center cell positioned within a middle row and a third column of the 3x5 matrix.

3. The gaming machine of claim 1, wherein the one or more processors is programmed to execute the algorithm including the steps of:
initiating a subsequent spin of the reel game by:
holding each prize reel displaying a prize symbol in place while animating each prize reel displaying a non-prize symbol and the bonus feature reel to spin;
stopping the spinning prize reels and the bonus feature reel to display one or more additional prize symbols and the prize reveal symbol; and
initiating a prize reveal animation sequence by:
randomly selecting a second number of cells displaying prize symbols based on the number of collected prize reveal symbols included in the prize reveal symbol meter using the random number generator;
determining a type of prize symbol being displayed in each selected cell;
accessing a prize reveal data lookup table to determine a plurality of credit prize values associated with each type of prize symbol being displayed in each selected cell;
randomly selecting a credit prize value from the associated plurality of credit prize values associated for each prize symbol being displayed in each selected cell using the random number generator; and
sequentially animating each selected credit prize value to overlay each corresponding prize symbol displayed in each selected cell.

4. The gaming machine of claim 3, wherein the one or more processors is programmed to execute the algorithm including the steps of:
displaying a credit meter above the grid; and
increasing an amount of credits being displayed in the credit meter based on each selected credit prize value as each selected credit prize value is overlayed over each corresponding prize symbol; and
removing each selected credit prize value from the grid after increasing the amount of credits displayed in the credit meter.

5. The gaming machine of claim 4, wherein the one or more processors is programmed to execute the algorithm including the steps of:
initiating another subsequent spin of the reel game by:
holding each prize reel displaying a prize symbol in place while animating each prize reel displaying a non-prize symbol and the bonus feature reel to spin;
stopping the spinning prize reels and the bonus feature reel to display one or more additional prize symbols and the wheel chance symbol; and
initiating a wheel chance animation sequence by:
animating a wheel to appear above the grid including a plurality of multiplier values;
accessing the prize reveal data lookup table to determine the plurality of credit prize values associated with each type of prize symbol being displayed;
randomly selecting a second credit prize value from the associated plurality of credit prize values associated with each prize symbol being displayed using the random number generator;
animating each selected second credit prize value to overlay each corresponding prize symbol being displayed;
randomly selecting a multiplier value being displayed on the wheel using the random number generator;
animating the wheel to rotate and stop to identify the randomly selected multiplier value; and
modifying each second credit prize value to increase based on the randomly selected multiplier value.

6. The gaming machine of claim 5, wherein the one or more processors is programmed to execute the algorithm including the steps of:
sequentially animating each selected second credit prize value to overlay each corresponding prize symbol in a sequential order by displaying a lowest credit prize value first and displaying a highest credit prize value last.

7. The gaming machine of claim 6, wherein the one or more processors is programmed to execute the algorithm including the steps of:
increasing the amount of credits being displayed in the credit meter based on each modified second credit prize value.

8. A method of operating a gaming machine for displaying a computer-animated reel game, the gaming machine including a gaming cabinet, a display device mounted to the cabinet and including a graphical user interface (GUI) display screen displaying computer-generated images thereon, and a control unit including a random number generator and one or more processors coupled to the display device, the method including the one or more processors performing an algorithm to display an animated sequence of computer-generated images of the computer-animated reel game on the display device GUI including the steps of:
rendering a game screen on the display device GUI including a grid having a plurality of cells arranged in a three row by five column (3x5) matrix, a prize upgrade symbol meter displaying a number of collected prize upgrade symbols, and a prize reveal symbol meter displaying a number of collected prize reveal symbols;
rendering a plurality of individual reels within the grid displaying a plurality of game symbols, the plurality of individual reels including a plurality of prize reels and a bonus feature reel, each prize reel displaying a plurality of prize symbols and a plurality of non-prize symbols, the bonus feature reel displaying a prize upgrade symbol, a prize reveal symbol, a wheel chance symbol, and a plurality of non-prize symbols;
initiating a spin of the reel game by animating the plurality of individual reels to spin and stop to display the game symbols within the grid including one or more prize symbols and the prize upgrade symbol;
initiating a prize upgrade animation sequence by:
randomly selecting a number of cells displaying prize symbols based on the number of collected prize upgrade symbols included in the prize upgrade symbol meter using the random number generator;
determining a type of prize symbol being displayed in each selected cell;
accessing a prize upgrade data lookup table to determine an upgrade prize symbol associated with each type of prize symbol being displayed in each selected cell; and
sequentially animating each associated upgrade prize symbol to replace a corresponding prize symbol displayed in each selected cell.

9. The method of claim 8, including the one or more processors performing the algorithm including the steps of:
rendering the bonus feature reel with a center cell positioned within a middle row and a third column of the 3x5 matrix.

10. The method of claim 8, including the one or more processors performing the algorithm including the steps of:
initiating a subsequent spin of the reel game by:
holding each prize reel displaying a prize symbol in place while animating each prize reel displaying a non-prize symbol and the bonus feature reel to spin;
stopping the spinning prize reels and the bonus feature reel to display one or more additional prize symbols and the prize reveal symbol; and
initiating a prize reveal animation sequence by:
randomly selecting a second number of cells displaying prize symbols based on the number of collected prize reveal symbols included in the prize reveal symbol meter using the random number generator;
determining a type of prize symbol being displayed in each selected cell;
accessing a prize reveal data lookup table to determine a plurality of credit prize values associated with each type of prize symbol being displayed in each selected cell;
randomly selecting a credit prize value from the associated plurality of credit prize values associated for each prize symbol being displayed in each selected cell using the random number generator; and
sequentially animating each selected credit prize value to overlay each corresponding prize symbol displayed in each selected cell.

11. The method of claim 10, including the one or more processors performing the algorithm including the steps of:
displaying a credit meter above the grid; and
increasing an amount of credits being displayed in the credit meter based on each selected credit prize value as each selected credit prize value is overlayed over each corresponding prize symbol; and
removing each selected credit prize value from the grid after increasing the amount of credits displayed in the credit meter.

12. The method of claim 11, including the one or more processors performing the algorithm including the steps of:
initiating another subsequent spin of the reel game by:
holding each prize reel displaying a prize symbol in place while animating each prize reel displaying a non-prize symbol and the bonus feature reel to spin;
stopping the spinning prize reels and the bonus feature reel to display one or more additional prize symbols and the wheel chance symbol; and
initiating a wheel chance animation sequence by:
animating a wheel to appear above the grid including a plurality of multiplier values;
accessing the prize reveal data lookup table to determine the plurality of credit prize values associated with each type of prize symbol being displayed;
randomly selecting a second credit prize value from the associated plurality of credit prize values associated with each prize symbol being displayed using the random number generator;
animating each selected second credit prize value to overlay each corresponding prize symbol being displayed;
randomly selecting a multiplier value being displayed on the wheel using the random number generator;
animating the wheel to rotate and stop to identify the randomly selected multiplier value; and
modifying each second credit prize value to increase based on the randomly selected multiplier value.

13. The method of claim 12, including the one or more processors performing the algorithm including the steps of:
sequentially animating each selected second credit prize value to overlay each corresponding prize symbol in a sequential order by displaying a lowest credit prize value first and displaying a highest credit prize value last.

14. The method of claim 13, including the one or more processors performing the algorithm including the steps of:
increasing the amount of credits being displayed in the credit meter based on each modified second credit prize value.

15. A non-transitory computer-readable storage media having computer-executable instructions embodied thereon to operate a gaming machine for displaying a computer-animated reel game, the gaming machine including a gaming cabinet, a display device mounted to the cabinet and including a graphical user interface (GUI) display screen displaying computer-generated images thereon, and a control unit including a random number generator and one or more processors coupled to the display device, when executed by the one or more processors the computer-executable instructions cause the one or more processors to perform an algorithm to display an animated sequence of computer-generated images of the computer-animated reel game on the display device GUI including the steps of:
rendering a game screen on the display device GUI including a grid having a plurality of cells arranged in a three row by five column (3x5) matrix, a prize upgrade symbol meter displaying a number of collected prize upgrade symbols, and a prize reveal symbol meter displaying a number of collected prize reveal symbols;
rendering a plurality of individual reels within the grid displaying a plurality of game symbols, the plurality of individual reels including a plurality of prize reels and a bonus feature reel, each prize reel displaying a plurality of prize symbols and a plurality of non-prize symbols, the bonus feature reel displaying a prize upgrade symbol, a prize reveal symbol, a wheel chance symbol, and a plurality of non-prize symbols;
initiating a spin of the reel game by animating the plurality of individual reels to spin and stop to display the game symbols within the grid including one or more prize symbols and the prize upgrade symbol;
initiating a prize upgrade animation sequence by:
randomly selecting a number of cells displaying prize symbols based on the number of collected prize upgrade symbols included in the prize upgrade symbol meter using the random number generator;
determining a type of prize symbol being displayed in each selected cell;
accessing a prize upgrade data lookup table to determine an upgrade prize symbol associated with each type of prize symbol being displayed in each selected cell; and
sequentially animating each associated upgrade prize symbol to replace a corresponding prize symbol displayed in each selected cell.

16. The non-transitory computer-readable storage media of claim 15, wherein the computer-executable instructions cause the one or more processors to perform the algorithm including the steps of:
rendering the bonus feature reel with a center cell positioned within a middle row and a third column of the 3x5 matrix.

17. The non-transitory computer-readable storage media of claim 15, wherein the computer-executable instructions cause the one or more processors to perform the algorithm including the steps of:
initiating a subsequent spin of the reel game by:
holding each prize reel displaying a prize symbol in place while animating each prize reel displaying a non-prize symbol and the bonus feature reel to spin;
stopping the spinning prize reels and the bonus feature reel to display one or more additional prize symbols and the prize reveal symbol; and
initiating a prize reveal animation sequence by:
randomly selecting a second number of cells displaying prize symbols based on the number of collected prize reveal symbols included in the prize reveal symbol meter using the random number generator;
determining a type of prize symbol being displayed in each selected cell;
accessing a prize reveal data lookup table to determine a plurality of credit prize values associated with each type of prize symbol being displayed in each selected cell;
randomly selecting a credit prize value from the associated plurality of credit prize values associated for each prize symbol being displayed in each selected cell using the random number generator; and
sequentially animating each selected credit prize value to overlay each corresponding prize symbol displayed in each selected cell.

18. The non-transitory computer-readable storage media of claim 17, wherein the computer-executable instructions cause the one or more processors to perform the algorithm including the steps of:
displaying a credit meter above the grid; and
increasing an amount of credits being displayed in the credit meter based on each selected credit prize value as each selected credit prize value is overlayed over each corresponding prize symbol; and
removing each selected credit prize value from the grid after increasing the amount of credits displayed in the credit meter.

19. The non-transitory computer-readable storage media of claim 18, wherein the computer-executable instructions cause the one or more processors to perform the algorithm including the steps of:
initiating another subsequent spin of the reel game by:
holding each prize reel displaying a prize symbol in place while animating each prize reel displaying a non-prize symbol and the bonus feature reel to spin;
stopping the spinning prize reels and the bonus feature reel to display one or more additional prize symbols and the wheel chance symbol; and
initiating a wheel chance animation sequence by:
animating a wheel to appear above the grid including a plurality of multiplier values;
accessing the prize reveal data lookup table to determine the plurality of credit prize values associated with each type of prize symbol being displayed;
randomly selecting a second credit prize value from the associated plurality of credit prize values associated with each prize symbol being displayed using the random number generator;
animating each selected second credit prize value to overlay each corresponding prize symbol being displayed;
randomly selecting a multiplier value being displayed on the wheel using the random number generator;
animating the wheel to rotate and stop to identify the randomly selected multiplier value; and
modifying each second credit prize value to increase based on the randomly selected multiplier value.

20. The non-transitory computer-readable storage media of claim 19, wherein the computer-executable instructions cause the one or more processors to perform the algorithm including the steps of:
sequentially animating each selected second credit prize value to overlay each corresponding prize symbol in a sequential order by displaying a lowest credit prize value first and displaying a highest credit prize value last; and
increasing the amount of credits being displayed in the credit meter based on each modified second credit prize value.
